(19) United States
(12) Patent Application Publication
(10) Pub. No.: US 2025/0300697 A1
(43) Pub. Date: Sep. 25, 2025

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Jian DANG, Nanjing, Jiangsu (CN); Hongwei ZHU, Nanjing, Jiangsu (CN); Tingting FAN, Beijing (CN); Chen SUN, Beijing (CN)

(73) Assignee: Sony Group Corporation, Tokyo (JP)

(21) Appl. No.: 18/861,633

(22) PCT Filed: May 9, 2023
(86) PCT No.: PCT/CN2023/092894

§ 371 Date: Oct. 30, 2024

(30) Foreign Application Priority Data
May 13, 2022 (CN) 202210520713.5

(51) Int. Cl. H04B 7/04; H04W 72/1263; H04W 74/0833

(52) U.S. Cl. CPC H04B 7/04013; H04W 72/1263; H04W 74/0833

(57) ABSTRACT

An electronic device and method for wireless communication, and a computer-readable storage medium. The electronic device for wireless communication may comprise a processing circuit, and the processing circuit may be configured to: when a current serving base station of a user equipment is overloaded, obtain a measurement result of a communication link, between the user equipment and an alternative base station, assisted by an intelligent reflecting surface; and when the measurement result of the communication link is higher than a threshold value, enable the user equipment to access the alternative base station and perform communication between the user equipment and the alternative base station under the assistance of the intelligent reflecting surface.

The present application claims priority to Chinese Patent Application No. 202210520713.5, titled “ELECTRONIC DEVICE AND METHOD FOR WIRELESS COMMUNICATION, AND COMPUTER-READABLE STORAGE MEDIUM”, filed on May 13, 2022 with the China National Intellectual Property Administration, which is incorporated herein by reference in its entirety.

### FIELD

The present disclosure relates to the technical field of wireless communications, and in particular to an electronic device and a method for wireless communication for improving user communication experience, and a computer-readable storage medium.

### BACKGROUND

In the 5th generation (5G) mobile communication technology, many scenarios have frequent business operations and large amounts of data. Although data transmission rates may be improved with the large bandwidth in 5G, a current serving base station of a user may be overloaded, for example, the current serving base station of the user cannot allocate uplink and/or downlink resources for the user and thus cannot perform uplink and/or downlink transmission with the user. Compared to the downlink transmission, limited uplink resources further limit the uplink transmission between the user and the serving base station, for example, the proportion of uplink time slots is only 30% in some commonly used frame structures, resulting in poor uplink communication experience for users.

Therefore, it is required to provide an enhanced technology to improve the user communication experience.

### SUMMARY

A brief summary of the present disclosure is given below to provide a basic understanding in some aspects of the present disclosure. It should be understood that the summary is not an exhaustive summary of the present disclosure. The summary is not intended to determine a critical part or an important part of the present disclosure or limit the scope of the present disclosure. A purpose of the summary is only to provide some concepts in a simplified manner, serving as a preamble of a more detailed description described later.

An electronic device and a method for wireless communication, and a computer-readable storage medium are provided according to the embodiments of the present disclosure. According to the present disclosure, a user equipment, in a case that a current serving base station is overloaded, is appropriately controlled to access a candidate base station to perform communication between the user equipment and the candidate base station with assistance of an intelligent reflecting surface, thereby improving user communication experience.

According to a first aspect of the present disclosure, an electronic device for wireless communication at a base station side is provided. The electronic device includes processing circuitry. The processing circuitry is configured to: obtain a measurement result of a communication link between a user equipment and a candidate base station with assistance of an intelligent reflecting surface in a case that a current serving base station of the user equipment is overloaded; and enable the user equipment to access the candidate base station and perform communication between the user equipment and the candidate base station with assistance of the intelligent reflecting surface in a case that the measurement result of the communication link is higher than a threshold.

According to a first aspect of the present disclosure, a method for wireless communication at a base station side is provided. The method includes: obtaining a measurement result of a communication link between a user equipment and a candidate base station with assistance of an intelligent reflecting surface in a case that a current serving base station of the user equipment is overloaded; and enabling the user equipment to access the candidate base station and perform communication between the user equipment and the candidate base station with assistance of the intelligent reflecting surface in a case that the measurement result of the communication link is higher than a threshold.

According to a second aspect of a first embodiment of the present disclosure, an electronic device for wireless communication at a user equipment side is provided. The electronic device includes processing circuitry. The processing circuitry is configured to: transmit an uplink signal for measuring a communication link between a user equipment and a candidate base station with assistance of an intelligent reflecting surface in a case that a current serving base station is overloaded; and access the candidate base station and perform communication between the user equipment and the candidate base station with assistance of the intelligent reflecting surface in a case that a measurement result of the communication link is higher than a threshold.

According to a second aspect of a first embodiment of the present disclosure, a method for wireless communication at a user equipment side is provided. The method includes: transmitting an uplink signal for measuring a communication link between a user equipment and a candidate base station with assistance of an intelligent reflecting surface in a case that a current serving base station is overloaded; and accessing the candidate base station and performing communication between the user equipment and the candidate base station with assistance of the intelligent reflecting surface in a case that a measurement result of the communication link is higher than a threshold.

According to another aspect of the present disclosure, a non-transitory computer-readable storage medium storing executable instructions is provided. The executable instructions, when executed by a processor, cause the processor to perform functions of the electronic device and the method for wireless communication described above.

According to other aspects of the present disclosure, computer program codes and computer program products for performing the method according to the present disclosure are further provided.

According to at least one aspect of the present disclosure, in a case that a current serving base station of a user equipment (UE) is overloaded, a measurement result of a communication link between the user equipment and a candidate base station with assistance of an intelligent reflecting surface (IRS) is obtained, and the user equipment is enabled to access the candidate base station and perform communication between the user equipment and the candidate base station with assistance of the intelligent reflecting surface in a case that the measurement result is higher than a threshold.

Correspondingly, using at least one aspect of the present disclosure, there may be more base stations (such as candidate base stations that are originally unable to effectively serve the user equipments but can effectively serve the user equipments with assistance of IRSs) capable of serving the user equipments (such as but not limited to allocating transmission resources to the user equipments), thereby improving user experience, and especially improving user experience in uplink communication for which transmission resources are particularly limited.

Other aspects of the embodiments of the present disclosure are provided in the following specification, in which preferred embodiments for fully disclosing the embodiments of the present disclosure are described in detail without imposing restrictions on the embodiments of the present disclosure.

### BRIEF DESCRIPTION OF THE DRAWINGS

The accompanying drawings described herein only illustrate some selected embodiments rather than all possible implementations, and are not intended to limit the scope of the present disclosure. In the drawing:

FIGS. 1A to 1C are schematic diagrams showing application scenarios of uplink communications of user equipments (UEs) with assistance of an intelligent reflecting surface (IRS) according to the present disclosure;

FIG. 2 is a block diagram showing a configuration example of an electronic device at a base station side according to an embodiment of the present disclosure;

FIG. 3 is a block diagram showing a configuration example of a measurement result obtaining unit in the electronic device shown in FIG. 2;

FIG. 4 is a schematic diagram showing partial exemplary information exchange between a UE, a current serving base station BS1 of the UE, and a candidate base station BS2 in a dynamic handover;

FIG. 5 is a schematic diagram showing partial exemplary information exchange between a UE, a BS1, a BS2 and an IRS in a dynamic handover;

FIG. 6 is a schematic diagram showing partial exemplary information exchange between a UE, a BS1 and a BS2 in a dynamic handover;

FIG. 7 is a schematic diagram showing partial exemplary information exchange between a UE, a BS1, a BS2, an IRS1, and an IRS2 in a dynamic handover;

FIG. 8 is a schematic diagram showing partial exemplary information exchange between a UE and a BS1 in a semi-static handover;

FIG. 9 is a schematic diagram showing partial exemplary information exchange between a UE and a BS2 in a semi-static handover;

FIG. 10 is a schematic diagram showing partial exemplary information exchange between a UE, a BS1, a BS2 and an IRS in a semi-static handover;

FIG. 11 is a schematic diagram showing partial exemplary information exchange between a UE, a BS1, a BS2 and an IRS in a semi-static handover;

FIG. 12 is a schematic diagram showing partial exemplary information exchange between a UE, a BS1 and a BS2 in a semi-static handover;

FIG. 13 is a schematic diagram showing partial exemplary information exchange between a UE, a BS2 and an IRS in a measurement process after handover;

FIG. 14 is a schematic diagram showing partial exemplary information exchange between a UE, a BS2 and an IRS in a measurement process after handover;

FIG. 15 is a block diagram showing a configuration example of an electronic device at a user equipment side according to an embodiment of the present disclosure;

FIG. 16 is a flowchart showing an exemplary process of a method for wireless communication at a base station side according to an embodiment of the present disclosure;

FIG. 17 is a flowchart showing an exemplary process of a method for wireless communication at a user equipment side according to an embodiment of the present disclosure;

FIG. 18 is a block diagram showing a first example of a schematic configuration of an eNB to which the technology of the present disclosure may be applied;

FIG. 19 is a block diagram showing a second example of a schematic configuration of an eNB to which the technology of the present disclosure may be applied;

FIG. 20 is a block diagram showing an example of a schematic configuration of a smartphone to which the technology according to the present disclosure may be applied; and

FIG. 21 is a block diagram showing an example of a schematic configuration of a vehicle navigation device to which the technology according to the present disclosure may be applied.

Although the present disclosure may be susceptible to various modifications and alternative forms, specific embodiments thereof have been shown by way of examples in the drawings and have been described in detail herein. However, it should be understood that the description of specific embodiments herein is not intended to limit the present disclosure to the particular forms disclosed, but rather to cover all modifications, equivalents, and alternatives falling within the spirit and scope of the present disclosure. It should be noted that same or similar reference numerals are used throughout the drawings to refer to the same or like parts.

### DETAILED DESCRIPTION OF EMBODIMENTS

The embodiments of the present disclosure will be described completely in conjunction with the drawings. The following description is only exemplary, and is not intended to limit the present disclosure, and applications or usages thereof.

Exemplary embodiments are provided so that the present disclosure will be thorough and complete, and will fully convey the scope of the present disclosure to those skilled in the art. Numerous specific details, such as examples of specific components, devices, and methods, are described to provide a detailed understanding of the embodiments of the present disclosure. It is apparent for those skilled in the art that the exemplary embodiments may be implemented in many different forms without specific details, and should not be construed to limit the scope of the present disclosure. In some exemplary embodiments, well-known processes, well-known structures, and well-known technologies are not described in detail.

The descriptions are provided in the following order:
1. Summary;
2. Configuration examples of an electronic device at a base station side;
   2.1 Configuration examples;
   2.2 Exemplary processes of dynamic handover;
   2.3 Exemplary processes of semi-static handover;
   2.4 Exemplary processes of measurement after handover;
3. Configuration examples of an electronic device at a user equipment side;
4. Method embodiments; and
5. Application examples.

### 1. SUMMARY

As mentioned above, in 5G communication, a current serving base station of a user may be overloaded, for example, the current serving base station of the user cannot allocate uplink and/or downlink resources for the user and thus cannot perform uplink and/or downlink transmission with the user.

In some 5G applications (such as 5G extended reality (XR)) scenarios, uplink services are frequent have large amounts of data. Compared to downlink transmission, limited uplink resources further limit an uplink transmission between a user and a serving base station of the user. For example, in some commonly used frame structures, the proportion of uplink time slots is only 30%. In addition, uplink transmission is further limited by high path loss in the high-frequency band (and correspondingly smaller uplink coverage ranges of terminals). Unlike the downlink coverage range that may be expanded by increasing transmission power by base stations, the uplink coverage range is limited by transmission powers of user terminals. Correspondingly, there may be a situation in which a user equipment is located within downlink coverage ranges of two base stations, but only one of the base stations is within an uplink coverage range of the user equipment, so that the user equipment can only perform uplink transmission with that one base station.

In view of the above situation, an inventive concept of appropriately utilizing an intelligent reflecting surface (IRS) to assist communication between user equipments and candidate base stations is provided. The intelligent reflecting surface is a planar array including a large number of passive reflecting units. By adjusting reflecting coefficients (amplitudes and/or phases) of the reflecting units, an amplitude and/or a phase of an incident signal of the intelligent reflecting surface may be changed, thereby achieving beamforming of a reflected signal and changing wireless channels accordingly.

Specifically, the following inventive concept is provided. In a case that a current serving base station of a user equipment (UE) is overloaded, a measurement result of a communication link between the UE and a candidate base station (where the candidate base station may be, for example, a neighboring base station located near the UE and/or the current serving base station, and there is an IRS between the neighboring base station and the UE that may assist in communication between the neighboring base station and the UE) with assistance of an intelligent reflecting surface (IRS) is obtained, and the UE is enabled to access the candidate base station and perform communication between the UE and the candidate base station with assistance of the intelligent reflecting surface in a case that the measurement result is higher than a threshold.

In the context of the present disclosure, the process of the UE accessing the candidate base station based on the measurement result of the communication link between the UE and the candidate base station with assistance of the IRS is referred to as an intelligent reflecting surface IRS assisted handover process. With the IRS assisted handover process, a reflecting link between the UE and the base station (that is, the candidate base station before handover) may be used, more base stations (such as the candidate base station that is originally unable to effectively serve the UE but can effectively serve the UE with assistance of the IRS) being capable of serving the UE (such as but not limited to allocating transmission resources for the UE). This is especially beneficial in expanding the uplink coverage range of the UE in uplink handover, thereby improving user experience, especially improving user experience in uplink communication for which transmission resources/coverage ranges are particularly limited.

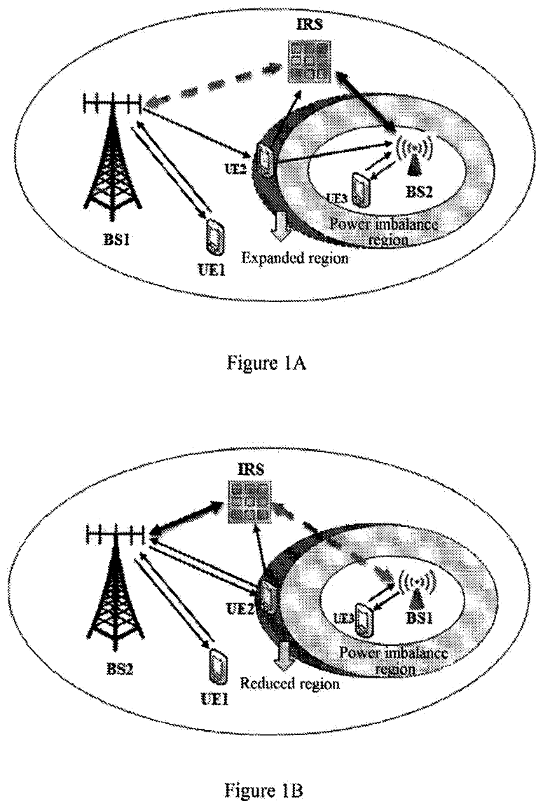

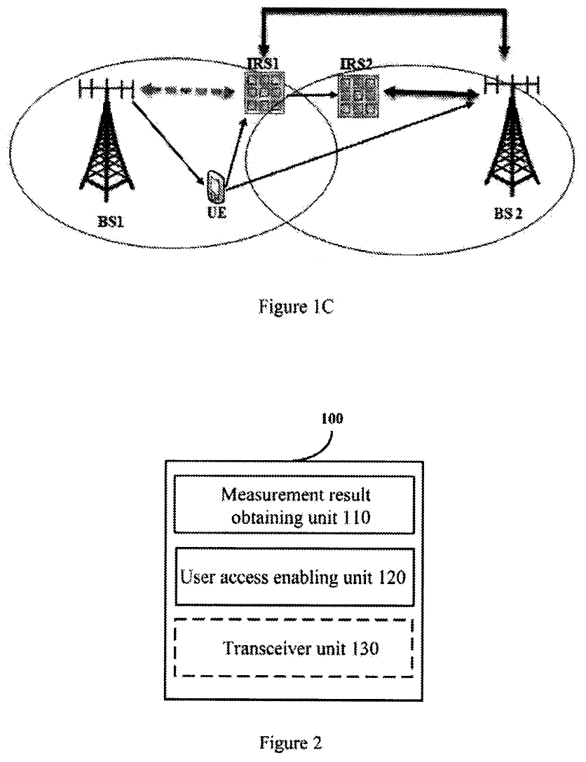

As an example, FIGS. 1A to 1C show application scenarios of uplink communications of user equipments (UEs) with assistance of an intelligent reflecting surface (IRS) according to the above inventive concept. FIG. 1A shows a heterogeneous network including a macro base station BS1 and a micro base station BS2. FIG. 1B shows a heterogeneous network including a micro base station BS1 and a macro base station BS2. FIG. 1C shows a heterogeneous network including macro base stations BS1 and BS2. In the scenarios, signaling interactions between the base stations and the intelligent reflecting surface are shown with bold double arrows, and uplink or downlink transmissions between the base stations and the user equipments are shown with single arrows.

Firstly, reference is made to FIGS. 1A and 1B. In the examples of the heterogeneous networks shown in FIGS. 1A and 1B, power imbalance regions represented by grayscale ellipses exist. In the power imbalance regions, in the downlink direction, the strengths of the signals of the macro base station (BS1 in FIG. 1A or BS2 in FIG. 1B) received by the user equipments are greater than the strengths of the signals of the micro base station (BS2 in FIG. 1A or BS1 in FIG. 1B) received by the user equipments; and in the uplink direction, the strengths of the signals of the user equipments received by the micro base station (BS2 in FIG. 1A or BS1 in FIG. 1B) are greater than the strengths of the signals of the UEs received by the macro base station (BS1 in FIG. 1A or BS2 in FIG. 1B).

In the example shown in FIG. 1A, the serving base station of the user equipment UE2, which is originally located outside the power imbalance region, is originally the macro base station BS1. In a case that the macro base station BS1 is overloaded, UE2 may handover to the micro base station BS2 with the assistance of the intelligent reflecting surface IRS. In this example, only the uplink is switched to the micro base station BS2, and the downlink remains for the access to the macro base station BS1. With the above handover process, the power imbalance region is expanded (by a region at a left side of the grayscale ellipse shown in FIG. 1A), and the uplink coverage range of UE2 is expanded, thereby improving the user's uplink communication experience.

In the example shown in FIG. 1B, the uplink serving base station of the user equipment UE2, which was originally located in the power imbalance region, is originally the micro base station BS1, and the downlink serving base station of the user equipment UE2 is originally the macro base station BS2. In a case that the micro base station BS1 is overloaded, the uplink may be switched to the macro base station BS2 with the assistance of the intelligent reflecting surface IRS, that is, both the uplink and the downlink are for the access to the macro base station BS2. With the above handover process, the power imbalance region is reduced (by a region at a left side of the grayscale ellipse shown in FIG. 1B), and the uplink coverage range of UE2 is expanded, thereby improving the user's uplink communication experience.

Next, reference is made to FIG. 1C. In the example shown in FIG. 1C, the serving base station of the user equipment UE is originally the macro base station BS1. In a case that the macro base station BS1 is overloaded, the UE may handover to another macro base station BS2 with assistance of the intelligent reflecting surfaces IRS1 and IRS2. In this example, only the uplink is switched to the macro base station BS2, and the downlink remains for the access to macro base station BS1. With the above handover process, the uplink coverage range of the UE is expanded, thereby improving the user's uplink communication experience. It should be noted that in the example shown in FIG. 1C, although IRS1 is originally in the coverage range of BS1 and is controlled by BS1, BS2 may obtain relevant information about IRS1 through communication with BS1 (such as device to device (D2D) communication) and then control IRS1 to assist in the communication between BS2 and the UE.

Next, devices and methods at a base station side and at a user side according to the embodiments of the present disclosure are further described in conjunction with the exemplary scenarios shown in FIGS. 1A to 1C. It should be noted that although the above description and following specific description are performed partially with the application scenarios of uplink handover as examples, the embodiments of the present disclosure are not limited to the scenarios of uplink handover. Those skilled in the art should understand that based on the description in the present disclosure, uplink handover and downlink handover may be simultaneously performed or only downlink handover is performed, which is be repeated herein.

### 2. CONFIGURATION EXAMPLES OF AN ELECTRONIC DEVICE AT A BASE STATION SIDE

### 2.1 Configuration Examples

FIG. 2 is a block diagram showing a configuration example of an electronic device at a base station side according to an embodiment of the present disclosure. The electronic device shown in FIG. 2, for example, may be used as a candidate base station in a handover process with assistance of an intelligent reflecting surface IRS.

As shown in FIG. 2, an electronic device 100 may include a measurement result obtaining unit 110, a user access enabling unit 120, and a transceiver unit 130 (which is optional). The transceiver unit 130 may (for example, under the control of the measurement result obtaining unit 110 and/or the user access enabling unit 120) transmit information to a device other than the electronic device 100 and/or receive information from a device other than the electronic device 100. In addition, although not shown in FIG. 2, the electronic device 100 may further include a storage unit.

All the units of the electronic device 100 may be included in processing circuitry. It should be noted that the electronic device 100 may include one processing circuitry or multiple processing circuitry. Further, the processing circuitry may include various discrete functional units to perform various functions and/or operations. It should be noted that the functional units may be physical entities or logical entities, and units with different titles may be implemented by the same physical entity.

The measurement result obtaining unit 110 may obtain a measurement result of a communication link between a user equipment and a candidate base station with assistance of an intelligent reflecting surface in a case that a current serving base station of the user equipment is overloaded. The abovementioned communication link may be referred to as an intelligent reflecting surface assisted communication link, and it includes a direct link between the user equipment and the candidate base station and a reflecting link between the user equipment and the candidate base station via the intelligent reflecting surface. As an example, the measurement result of the communication link obtained by the measurement result obtaining unit 110 may be a quality of a received signal of a reference signal transmitted via the communication link, such as a reference signal receiving power (RSRP).

Optionally, the measurement result obtaining unit 110 may, through information exchanges between the transceiver unit 130 and the user equipment, the current serving base station of the user equipment, and/or the intelligent reflecting surface, select and/or control the intelligent reflecting surface for assisting communication and control measurement of the communication link to obtain the measurement result, for example.

FIG. 3 shows a block diagram of a configuration example of a measurement result obtaining unit 110 of the electronic device 100. As shown in FIG. 3, the measurement result obtaining unit 110 may include an IRS determining unit 111, an IRS controlling unit 112, and a measurement unit 113 (which are optional).

The IRS determining unit 111, for example, may determine an intelligent reflecting surface that is located between a user equipment and a candidate base station and may be used for assisting communication based on, for example, information (such as a location or an orientation of the user equipment and optionally a transmission power of the user equipment) related to the user equipment obtained from the user equipment or the serving base station of the user equipment via the transceiver unit 130.

The IRS controlling unit 112, for example, may generate configuration information for the intelligent reflecting surface and transmit the configuration information for the intelligent reflecting surface to the intelligent reflecting surface via the transceiver unit 130 to control the intelligent reflecting surface. The configuration information, for example, may include but is not limited to reflecting coefficients of reflecting units of the intelligent reflecting surface, so that the intelligent reflecting surface changes the reflecting coefficients (amplitudes and/or phases) of the reflecting units based on the configuration information, thereby changing reflection beams under the control of the IRS controlling unit 112.

The measurement unit 113 may, for example, control and/or perform measurement of the communication link assisted by the intelligent reflecting surface through signals or information exchanges between the transceiver unit 130 and the user equipment, the current serving base station of the user equipment and the intelligent reflecting surface, so as to obtain the measurement result. For example, the measurement unit 113 may generate a measurement notification and provide the measurement notification to the UE via the current serving base station using the transceiver unit 130, so that the UE may receive downlink signals or transmit uplink signals based on indication of the measurement notification, so that measurement of a required communication link (such as but not limited to the communication link assisted by the IRS) can performed. The measurement unit 113 may further control the transceiver unit 130 to receive or transmit other signals or information related to the measurement of the communication link. In addition, the measurement unit 113 may directly measure an uplink signal received from the user equipment using the transceiver unit 130 to obtain the measurement result of the required communication link.

The user access enabling unit 120 of the electronic device 100 may enable the user equipment to access (uplink access and/or downlink access) the candidate base station and perform (uplink and/or downlink) communication between the user equipment and the candidate base station with assistance of the intelligent reflecting surface in a case that the measurement result of the communication link obtained by the measurement result obtaining unit 110 (the measurement unit 113) is higher than a threshold. The threshold for measurement result may be appropriately determined, either in advance or in real time, based on various factors (such as, a minimum, a maximum or an average requirement for communication quality, a minimum communication quality with a current serving base station, and a real-time communication quality with the current serving base station), which is not repeated herein.

As an example, the user access enabling unit 120 may, for example, based on information exchanges between the transceiver unit 130 and the user equipment and/or the current serving base station of the user equipment, cause the user equipment to disconnect (uplink and/or downlink) from the current serving base station and access (uplink and/or downlink) the candidate base station.

Optionally, the user access enabling unit 120 may include or have an IRS controlling unit (or share the IRS controlling unit 112 with the measurement result obtaining unit 110) similar to the IRS controlling unit 112 in the measurement result obtaining unit 110 shown in FIG. 3, to control the IRS to assist in the communication between the user equipment and the candidate base station by generating and transmitting configuration information of the IRS after the user equipment accesses the candidate base station. Alternatively, after the user equipment accesses the candidate base station, the measurement result obtaining unit 110, rather than the user access enabling unit 120, may continuously control the IRS to assist in the communication between the user equipment and the candidate base station through the IRS controlling unit 112. No particular limitation is provided in the present disclosure, as long as the electronic device 100 may control the IRS through information exchanges between the transceiver unit 130 and the intelligent reflecting surface, and thus communication between the user equipment and the candidate base station is performed with the assistance of the intelligent reflecting surface.

Preferably, after the user equipment accesses the candidate base station (for uplink and/or downlink connection), the user access enabling unit 120 of the electronic device 100 may, for example, control the transceiver unit 130 to communicate with the user equipment with the assistance of the IRS, using transmission resources similar to resources for the other user equipments in the coverage region of the electronic device 100 used for the candidate base station. In an example, the current serving base station of the user equipment and the electronic device 100 used for the candidate base station are both base stations in the 5G network. After causing the user equipment to handover to the candidate base station with assistance of the IRS, the user access enabling unit 120 of the electronic device 100 may control the transceiver unit 130 to communicate with the user equipment with assistance of the IRS using 5G high-frequency transmission resources, including but not limited to allocating 5G high-frequency uplink resources to the user equipment. Compared to the conventional technology, such as dual connection, supplemented uplink (SUL), or carrier aggregation, in which uplink enhancement is performed based on other uplink resources (rather than the 5G high-frequency uplink resources), the above optimized processing of the user access enabling unit 120 is beneficial for the applications of uplink services with frequent and large data transmission in 5G.

The electronic device 100 may perform a handover process with assistance of an intelligent reflecting surface using the measurement result obtaining unit 110, the user access enabling unit 120, and the optional transceiver unit 130 in various appropriate manners or processing.

As an example, a situation in which a current serving base station is overloaded and unable to allocate uplink resources for a user equipment may be considered. In this situation, after receiving an uplink scheduling request from the user equipment due to the current serving base station is overloaded, the intelligent reflecting surface assisted handover process may be initiated in response to a request for a candidate base station from the current serving base station or the user equipment.

In an example, the handover process may be initiated in a dynamical manner (dynamic handover). The electronic device 100, for example, receives, via the transceiver unit 130, relevant information about a user equipment and a measurement request for the communication link, which are transmitted to the candidate base station by the current serving base station of the user equipment when it receives the uplink scheduling request from the user equipment in the case that it is overloaded, and controls the measurement of the communication link based on the relevant information about the user equipment, for example, using the measurement result obtaining unit 110 based on the measurement request.

In another example, the handover process may be initiated in a semi-static manner (semi-static handover). The electronic device 100, for example, receives, for example, via the transceiver unit 130, a random access request from a user equipment to a candidate base station that is transmitted in a case that the user equipment cannot obtain uplink resources from an overloaded current serving base station, and controls the measurement of the communication link based on the received random access request using the measurement result obtaining unit 110.

Optionally, after completing the handover process with assistance of the intelligent reflecting surface, during the communication between the user equipment and the candidate base station with assistance of the intelligent reflecting surface the electronic device 100 may use the measurement result obtaining unit 110 and the transceiver unit 130 to transmit (via a communication link assisted by the intelligent reflecting surface or, specifically, only via a reflecting link) a downlink reference signal, such as a channel state information-reference signal (CSI-RS) to the user equipment, and obtain a measurement result of the user equipment on the downlink reference signal as a communication quality of the communication link assisted by the intelligent reflecting surface (measurement after handover), so as to change the used intelligent reflecting surface when necessary. For example, the electronic device 100 may, in a case that the communication quality of the IRS assisted communication link does not meet a requirement (such as less than a threshold), determine a new IRS if possible and use the new IRS to assist the communication between the candidate base station, that has become the serving base station, and the UE.

Next, with appropriate reference to the exemplary scenarios shown in FIGS. 1A to 1C, exemplary processes of the electronic device 100 and various units of the electronic device 100 at the base station side in the dynamic handover, the semi-static handover and the measurement after handover are further described. The electronic device 100, for example, may be used for the candidate base station BS2 shown in FIGS. 1A to 1C.

### 2.2 Exemplary Processes of Dynamic Handover

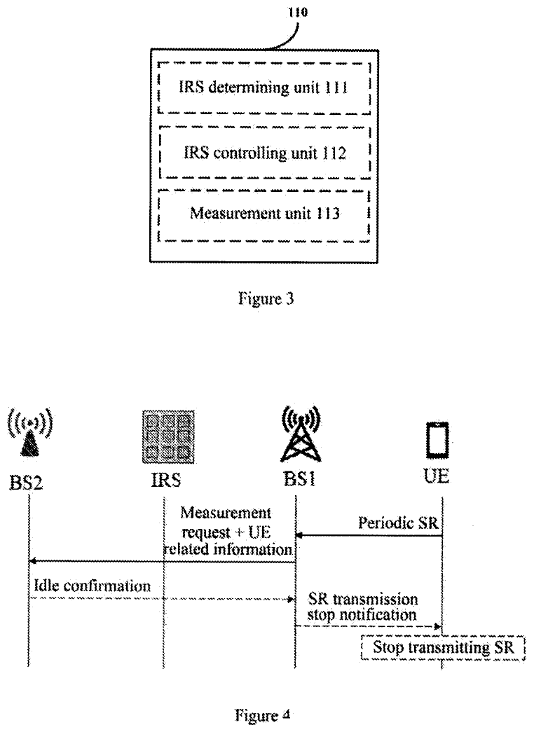

Next, with appropriate reference to the exemplary scenarios shown in FIGS. 1A to 1C, and referring to the exemplary information exchanges between a UE (such as UE2 in FIG. 1A or 1B and UE in FIG. 1C), a current serving base station BS1 of the UE, a candidate base station BS2 (having the function of the electronic device 100/implemented by the electronic device 100), and an intelligent reflecting surface (such as the IRS in FIG. 1A or 1B, or IRS1 or IRS2 in FIG. 1C) in a dynamic handover shown in FIGS. 4 to 7, exemplary processes of the electronic device 100 and various units of the electronic device 100 in the dynamic handover are described.

Firstly, reference is made to FIG. 4, which shows that a handover process with assistance of an intelligent reflecting surface is to be initiated (more specifically, a measurement process for an IRS assisted communication link is to be started) in response to a measurement request to a candidate base station from a current serving base station which receives, in a case of being overloaded, an uplink scheduling request from a user equipment.

As shown in FIG. 4, in an example of dynamic handover, when a current serving base station BS1 of a UE receives, in a case of being overloaded, an uplink scheduling request SR from a UE2, the overloaded current serving base station BS1 transmits an IRS assisted communication link measurement request and UE related information of the UE to the candidate base station BS2. The UE related information, for example, includes but is not limited to a location or an orientation of the UE, and a transmission power of the UE (which is optional). FIG. 4 shows an exemplary scenario in which BS1, after receiving SR, transmits a measurement request and UE related information simultaneously. It should be understood that the above exemplary scenario is not limiting, and BS1 may transmit the measurement request and the UE related information separately or sequentially after receiving the SR, which is not limited in the present disclosure.

Optionally, after the electronic device 100 used for the candidate base station BS2, for example, receives the measurement request (and the UE related information) via the transceiver unit 130, the electronic device 100, for example, transmits a confirmation message to BS1 via the transceiver unit 130 in a case that the electronic device 100 has idle uplink resources. After receiving the confirmation message, BS1 may transmit an SR transmission stop notification to the UE to inform the UE to stop transmitting SR. Alternatively, one or more of the optional processes mentioned above may be omitted.

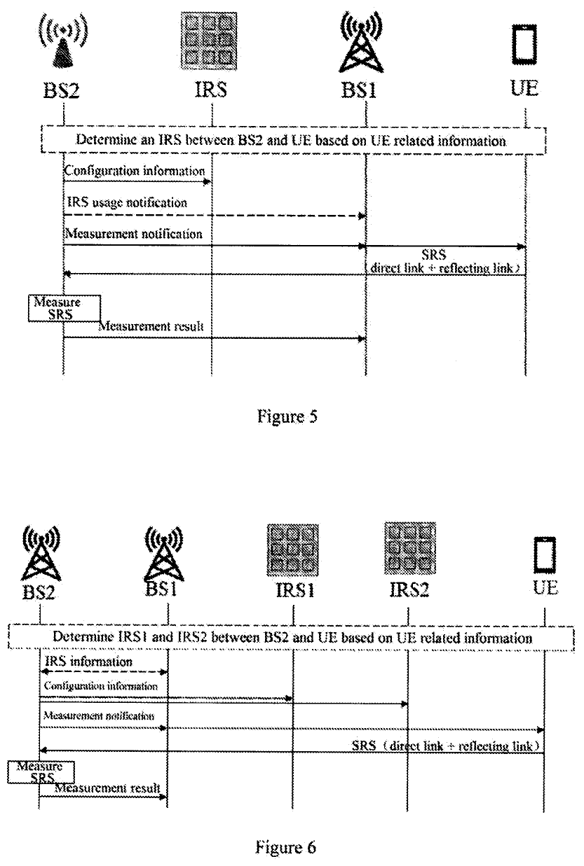

For example, after receiving the measurement request and the related information from the current serving base station of the UE, the electronic device 100 used for the candidate base station BS2 may start and control the exemplary measurement process for the IRS assisted communication link as shown in FIG. 5 by using the measurement result obtaining unit 110 and the access enabling unit 120.

As shown in FIG. 5, in the measurement process, firstly, optionally, the electronic device 100 used for the candidate base station BS2 determines an intelligent reflecting surface or multiple intelligent reflecting surfaces that can be cascaded between the user equipment UE and the candidate base station BS2 to assist communication, for example, by using the measurement result obtaining unit 110 (the IRS determining unit 111), based on the obtained UE related information (the position or the orientation of the UE, and optionally the transmission power of the UE). Preferably, the above determination may be performed based on a distance between the candidate base station and the user equipment, a distance between the user equipment and the intelligent reflecting surface, and/or the transmission power of the user equipment. For example, one or more intelligent reflecting surfaces that are closer to the UE and within an uplink coverage range of the UE may be determined. For example, one cascaded intelligent reflecting surface may be determined when the UE is closer to the candidate base station, and two or more cascaded intelligent reflecting surfaces may be determined when the UE is farther away from the candidate base station. In this example, the UE is located close to the candidate base station, and an intelligent reflecting surface IRS (such as the IRS shown in FIG. 1A or FIG. 1B) is determined.

In addition, the electronic device 100 used for the candidate base station BS2 may generate configuration information for the IRS, for example, by using the measurement result obtaining unit 110 (the IRS controlling unit 112), and transmit the configuration information, for example, through the transceiver unit 130, to the IRS, so that the IRS may change the reflecting coefficients (amplitudes and/or phases) of reflecting units of the IRS based on the configuration information, thereby controlling the IRS by changing reflection beams. As an example, the electronic device 100 may generate configuration information (IRS configuration information) for the intelligent reflecting surface based on a position relationship between the intelligent reflecting surface and the positions or orientations of the UE (which may be determined based on the obtained UE related information) and/or a position relationship between the intelligent reflecting surface and the candidate base station, and then control a first beam of the intelligent reflecting surface to be directed to the user equipment and/or a second beam of the intelligent reflecting surface to be directed to the candidate base station, to establish a reflecting link between the user equipment and the candidate base station via the intelligent reflecting surface. In this example, only one intelligent reflecting surface is used, and a first beam of the intelligent reflecting surface is controlled to be directed to the user equipment and a second beam of the intelligent reflecting surface is controlled to be directed to the candidate base station.

Optionally, in a case that the intelligent reflecting surface IRS is controlled by BS2 and is controlled by the current serving base station BS1, the electronic device 100 used for the candidate base station BS2 may generate an IRS usage notification, for example, by using the measurement result obtaining unit 110 (the IRS controlling unit 112), and transmit the usage notification to BS1, for example, through the transceiver unit to inform BS1 of its control over the IRS and cause BS1 to stop its control over the IRS.

Preferably, the electronic device 100 used for the candidate base station BS2 may further, for example, generate a measurement notification by using the measurement result obtaining unit 110 (the measurement unit 113), and provide the measurement notification to the UE, for example, by using the transceiver unit 130 via the current serving base station BS1, so that the UE transmits an uplink reference signal based on indication of the measurement notification, thereby performing the measurement on the IRS assisted communication link. The uplink reference signal may be transmitted through an IRS reflecting link established based on the IRS configuration information and optionally an optional direct link between the UE and the candidate base station BS2.

As an example, the measurement notification transmitted by the electronic device 100 to the current serving base station BS1, for example, via D2D communication, may indicate time-frequency resources for the UE to transmit the uplink reference signal, and may be transmitted to the UE, for example, as configuration information of the uplink reference signal after being processed and forwarded by the current serving base station BS1. As an example, the uplink reference signal transmitted by the UE may be a periodic sounding reference signal (SRS).

Optionally, the measurement notification sent by electronic device 100 may indicate beam information for the UE to transmit the uplink reference signal, for example, the beam information in this example indicates a wide beam such as an omnidirectional beam (or at least a beam covering both the IRS and the candidate base station BS2), so that the uplink reference signal from the UE may be transmitted via a direct link and a reflecting link between the UE and candidate base station BS2. That is, in this example, the UE may, based on indication of the received measurement notification, transmit the uplink reference signal, such as SRS, through the direct link between the UE and the candidate base station BS2 and the IRS reflecting link established between the UE and the candidate base station BS2 based on the IRS configuration information.

The electronic device 100 for the candidate base station BS2 may, for example, measure the uplink reference signal transmitted by the user equipment UE and received via the communication link including the reflecting link and the direct link between the user equipment UE and the candidate base station BS2 by using the measurement result obtaining unit 110 (the measurement unit 113), and may obtain the measurement result of the communication link based on the measurement result of the uplink reference signal.

In addition, the electronic device 100 used for the candidate base station BS2 may further provide, for example, via the transceiver unit 130, the measurement result of the communication link to the current serving base station BS1 of the user equipment UE through processing by the user access enabling unit 120 so that the current serving base station BS1 instructs the user equipment UE to disconnect from the current serving base station and access to the candidate base station BS2 in a case that the measurement result is higher than a threshold. As shown in FIG. 6, in a case that the measurement result provided by the electronic device 100 used for the candidate base station BS2 to the current serving base station BS1 is higher than a threshold, the current serving base station BS1 may instruct, through a RRC reconfiguration, the UE to disconnect (in uplink and/or downlink) from the current serving base station BS1 and perform a random access process with the candidate base station BS2. As an example, the handover process of the UE may be only is an uplink handover process (access to BS2 in uplink), and it may remain the access to BS1 in downlink in the case of decoupling of uplink and downlink. Alternatively, the UE may handover to BS2 both in uplink and in downlink.

In the exemplary measurement process shown in FIG. 5, it is shown that the electronic device 100 used for the candidate base station BS2 firstly transmits configuration information to the IRS, then transmits a measurement notification to the UE, and the UE transmits an uplink reference signal through both the direct link and the reflecting link based on indication of the received measurement notification for the electronic device 100 to perform measurement. It should be understood that the above examples are not limiting, and the electronic device 100 may exchange the orders of transmitting the configuration information to the IRS and transmitting the measurement notification to the UE, or even transmit the configuration information and the measurement notification simultaneously, and the electronic device 100 may modify the content of the measurement notification (for example, indicating a narrow beam to the UE, such as a directional beam for the IRS, instead of a wide beam to the UE), as long as the UE may transmit an uplink reference signal to the electronic device 100 for measurement via the IRS reflecting link (and optionally the direct link) established based on indication of the received measurement notification and the configuration information between the UE and BS2, which is not limited in the present disclosure.

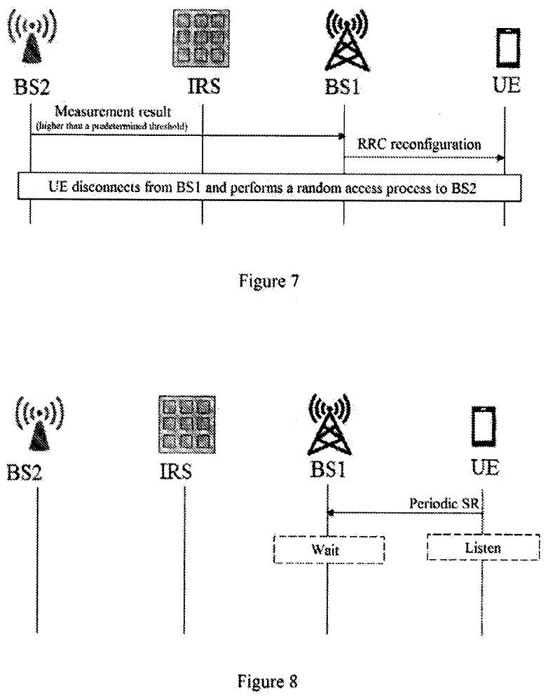

In addition, in the exemplary measurement process shown in FIG. 5, it shows a case in which the candidate base station determines one IRS for assisting communication. However, the candidate base station may, for example, determine multiple IRSs for assisting communication when the candidate base station is far away from the UE and/or the transmission power of the UE is low, as shown in FIG. 7.

FIG. 7 shows another exemplary measurement process of an IRS assisted communication link that may be controlled by the electronic device 100 used for the candidate base station BS2, in which the electronic device 100 for the candidate base station BS2 determines two cascaded intelligent reflecting surfaces IRS1 and IRS2 for assisting communication, IRS1 is located near the user equipment UE, and IRS2 is located near the candidate base station BS2. As shown in FIG. 7, it is required for the electronic device 100 used for the candidate base station BS2 to transmit configuration information to the two IRSs to control a first beam of the IRS1 near the UE to be directed to the UE, a second beam of the IRS2 near BS2 to be directed to BS2, and the two intelligent reflecting surfaces IRS1 and IRS2 to be directed to each other with other beams (a third beam and a fourth beam), thereby achieving a reflecting link assisted by cascaded intelligent reflecting surfaces.

Optionally, the current serving base station BS1 and the candidate base station BS2 in the example shown in FIG. 7 may be two macro base stations in a homogeneous network, as shown in FIG. 1C. Thus, as shown in FIG. 7, the two base stations may exchange IRS information of the intelligent reflecting surfaces in the coverage regions of the two base stations with each other (for example, BS1 provides IRS1 related information to BS2 and BS2 transmits an IRS usage notification to BS1), so that the candidate base station BS2 may utilize the IRS1 originally controlled by the current serving base station BS1.

Except for the above difference of using two cascaded intelligent reflecting surfaces IRS1 and IRS2 instead of a single intelligent reflecting surface for assisting communication (and optionally, BS2 exchanging IRS information with BS1 instead of BS2 transmitting an IRS usage notification to BS1), the exemplary measurement process shown in FIG. 7 is substantially the same as the exemplary measurement process shown in FIG. 5, and is not repeated herein.

### 2.3 Exemplary Processes of Semi-Static Handover

Next, with appropriate reference to the exemplary scenarios shown in FIGS. 1A and 1B, and referring to the exemplary information exchanges between a UE (such as UE2 in FIG. 1A or 1B), a current serving base station BS1 of the UE, a candidate base station BS2 (having the function of the electronic device 100/implemented by the electronic device 100), and an intelligent reflecting surface (such as the IRS in FIG. 1A or 1B) in a semi-static handover shown in FIGS. 8 to 12, exemplary processes of the electronic device 100 and various units of the electronic device 100 in the semi-static handover are described.

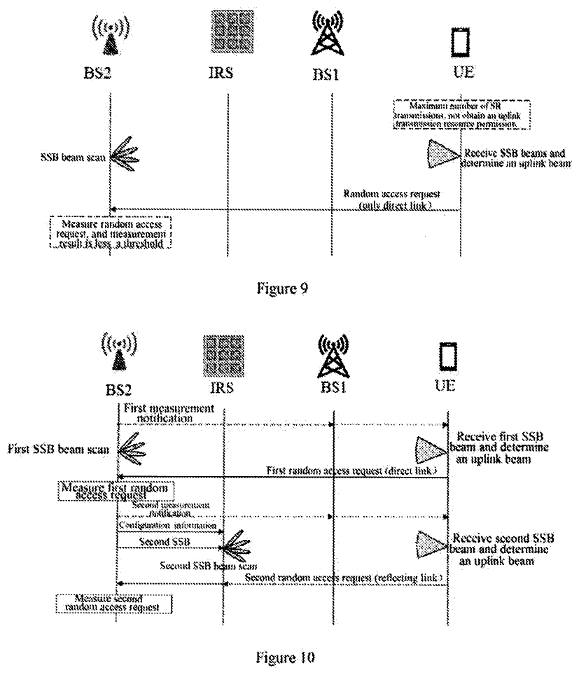

Firstly, reference is made to FIGS. 8 and 9, which shows that a handover process with assistance of an intelligent reflecting surface is to be initiated (more specifically, a measurement process for an IRS assisted communication link is to be started) in response to a random access request from a user equipment due to that the user equipment cannot obtain an uplink transmission resource permission after transmitting an uplink scheduling request to an overloaded current serving base station.

As shown in FIG. 8, in an example of semi-static handover, a UE continuously transmits a periodic SR to a current serving base station BS1 and listens to a physical downlink control channel (PDCCH) for obtaining an uplink transmission resource permission from BS1. The overloaded current serving base station BS1, after receiving an uplink scheduling request SR form the US2, waits and temporarily does not perform any operation.

As shown in FIG. 9, in a case that an intelligent reflecting surface is not used, for example, an electronic device 100 used for the candidate base station BS2 near the UE periodically performs, through a transceiver unit 130, a beam scan of a downlink reference signal such as a synchronization signal block (SSB), that is, transmitting SSBs in sequence with multiple downlink beams, to facilitate the user equipment performing cell search or accessing to the base station. For example, in a case that the number of SRs transmitted by the UE reaches a predetermined maximum value (or a predetermined time period has elapsed) and the UE has not yet obtained an uplink transmission resource permission from BS1, the UE receives beams of the SSB beam scan of the candidate base station BS2 with a receiving beam (for example, a wide beam such as an omnidirectional beam) and determines an uplink beam corresponding to one of downlink beams (such as a downlink beam with a highest RSRP of the signal received by the UE). As an example, different time instants for transmitting SSB may correspond to different downlink beams, and may be pre-associated with different preambles used for a random access request. Thus, the UE, in determining the uplink beam, determines, for example, a preamble for a random access request. Then, the UE may transmit a random access request (such as a preamble) to BS2 with the determined uplink beam.

The electronic device 100 used for the candidate base station BS2 may, for example, to measure a random access request from a UE received via the transceiver unit 130 by using the measurement result obtaining unit 110 (the measurement unit 113). In this example, the electronic device 100 used for the candidate base station BS2 determines that the measurement result is less than the threshold. The threshold may be predetermined or variable, and a measurement result less than the threshold indicate that the candidate base station cannot provide effective service to the user equipment.

Thus, the electronic device 100 used for the candidate base station BS2 needs to perform handover with assistance of an IRS, and may start and control an exemplary measurement process on an IRS assisted communication link as shown in FIG. 10, for example, by using the measurement result obtaining unit 110.

Due to that the uplink beam used by the UE to transmit the random access request actually carries position information or orientation information of the UE, the electronic device 100 at the base station side may determine, for example, based on beam symmetry (and/or an association between a preamble of a random access request and a downlink beam used for transmitting SSB), a downlink beam for transmitting the SSB that covers the UE, that is, obtain the position information or orientation information of the UE. Correspondingly, although not shown in FIG. 10, optionally, before the exemplary measurement process shown in FIG. 10, the electronic device 100 may determine an intelligent reflecting surface between the user equipment UE and the candidate base station BS2 based on the position information or the orientation information of the UE, for example, by using the measurement result obtaining unit 110 (the IRS determining unit 111), so as to assist in communication. Preferably, the above determination may be based on a distance between the intelligent reflecting surface and the user equipment. For example, a nearest intelligent reflecting surface to the UE may be determined, such as the IRS shown in FIG. 1A or FIG. 1B.

After determining the IRS for assisting communication, as shown in FIG. 10, the electronic device 100 used for the candidate base station BS2 may firstly sequentially transmit a first downlink reference signal (a first SSB) with multiple first beams (multiple downlink beams) by using the transceiver unit 130 to perform a first SSB scan, in a case that the intelligent reflecting surface is not used. For the first SSB scan, the UE performs reception, for example, with a receiving beam such as an omnidirectional beam, determines an uplink beam corresponding to one (such as a first beam with a highest RSRP of the received signal) of multiple first beams, and optionally simultaneously determines a preamble used for a random access request. Then, the UE may transmit a first random access request (such as a first preamble) to the candidate base station BS2 with the determined uplink beam.

Correspondingly, the electronic device 100 used for the candidate base station BS2 may, for example, measure the random access request from the UE received via the transceiver unit 130 and transmitted only via the direct link between the UE and the candidate base station BS2, by using the measurement result obtaining unit 110 (the measurement unit 113).

In addition, the electronic device 100 used for the candidate base station BS2 may transmit a second downlink reference signal (a second SSB) to the intelligent reflecting surface and control the intelligent reflecting surface to sequentially reflect the second SSB with multiple second beams (multiple reflection beams) to perform a second SSB scan. More specifically, as shown in FIG. 9, the electronic device 100 used for the candidate base station BS2 generates configuration information for the IRS, for example, by using the measurement result obtaining unit 110 (the IRS controlling unit 112), and transmits the configuration information to the IRS, for example, by using the transceiver unit 130, to control the IRS. In addition, the electronic device 100 used for the candidate base station BS2 transmits SSB to the IRS, for example, by using the transceiver unit 130, so that the IRS changes the reflection coefficients (amplitudes and/or phases) of reflecting units of the IRS based on the configuration information, thereby changing the reflection beams and sequentially reflecting SSB with multiple second beams, making it appear from the UE side that the base station performs a second SSB scan at the position of the IRS. Besides, based on the configuration information transmitted to the IRS (transmitted together with the above configuration information or transmitted separately at another appropriate time instant), the IRS may be controlled to direct another beam pair to the candidate base station, to establish a reflecting link between the user equipment and the candidate base station via the IRS.

Similar to the first SSB beam scan, the UE may perform reception with a receiving beam, such as an omnidirectional beam, for the second SSB beam scan, determines an uplink beam corresponding to one of multiple second beams (such as a second beam with a highest RSRP of the received signal), and optionally determines, for example, a preamble used for a random access request simultaneously. Then, the UE may transmit a second random access request (such as a second preamble) to the IRS with the determined uplink beam, and the second random access request transmitted with a directional beam is received by the candidate base station BS2 through the reflecting link via the IRS.

Correspondingly, the electronic device 100 used for the candidate base station BS2 may, for example, measure the second random access request received via the transceiver unit 130 from the UE that is only transmitted through the reflecting link via the IRS, by using the measurement result obtaining unit 110 (the measurement unit 113).

In the example shown in FIG. 10, the first SSB and the second SSB transmitted by the electronic device 100 for the candidate base station BS2 may be different or identical to each other. In an example, the first SSB and the second SSB are different from each other, and the UE side may deem the first SSB beam scan and the second SSB beam scan as SSB beam scans of two candidate base stations and process the SSB beam scans respectively. In another example, the first SSB and the second SSB are identical to each other. Thus, to make the UE aware that it is required for the UE to process the first SSB beam scan and the second SSB beam scan separately, preferably, as shown by the dashed line before each of the beam scans in the exemplary measurement process shown in FIG. 10, the electronic device 100 for the candidate base station BS2 may further generate a first measurement notification and a second measurement notification, for example, by using the measurement result obtaining unit 110 (the measurement unit 113), and provide the measurement notifications to the UE through the current serving base station BS1, for example, by using the transceiver unit 130, so that the UE may receive the SSB in response to the instructions in the measurement notifications. As an example, each of the measurement notifications transmitted by the electronic device 100 may indicate with minimal information the UE that the network side is to perform a SSB beam scan (the first SSB beam scan via the direct link or the second SSB beam scan using the IRS), facilitating the UE determining an uplink beam corresponding to a downlink beam for each of the two beam scans and transmitting a corresponding random access request using the determined uplink beam.

As described above, in the exemplary measurement process shown in FIG. 10, the electronic device 100 used for the candidate base station BS2 may not provide a measurement notification to the user equipment or provide a measurement notification containing only minimum information indicating that a SSB beam scan is to be performed, and the user equipment may use an omnidirectional beam as a receiving beam for the SSB beam scan. In an alternative example, the electronic device 100 used as the candidate base station BS2 may provide a measurement notification containing information about SSB to the user equipment. With the information, the user equipment may determine an appropriate receiving beam for receiving the SSB, so that the user equipment may use a narrow beam (instead of an omnidirectional beam) as a receiving beam for the SSB beam scan, thereby improving the effectiveness of the SSB beam scan, such as but not limited to improving efficiency and accelerating processing speed.

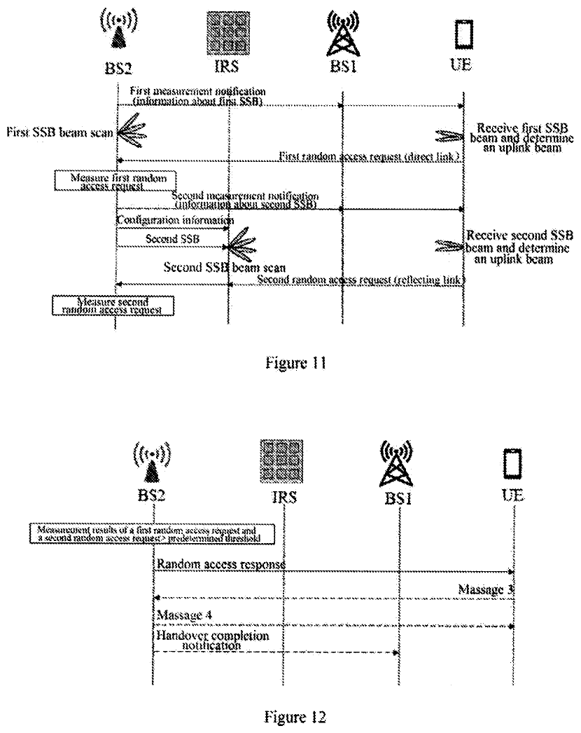

As an alternative example, FIG. 11 shows another exemplary measurement process on an IRS assisted communication link that may be controlled by an electronic device 100 used for a candidate base station BS2. The difference from the example shown in FIG. 10 is that, the first measurement notification provided by the candidate base station to the user equipment via the current serving base station of the user equipment includes first information about a first downlink reference signal where the first information includes relevant information about the candidate base station, and the second measurement notification provided by the candidate base station to the user equipment via the current serving base station of the user equipment includes second information about a second downlink reference signal where the second information includes relevant information about the intelligent reflecting surface. The above relevant information is beneficial for the user equipment to determine (by the user equipment itself or under the guidance of the serving base station) an appropriate receiving beam for receiving the downlink reference signal SSB, so that the user equipment may use, for the SSB beam scan, a corresponding narrow beam as shown in FIG. 11 (instead of the omnidirectional beam shown in FIG. 10) as a receiving beam, thereby improving the effectiveness of the SSB beam scan.

As an example, in the first measurement notification and the second measurement notification transmitted by the electronic device 100 used for the candidate base station BS2 shown in FIG. 11, the information about SSB includes relevant information about the candidate base station or the intelligent reflecting surface that can be, for example, position information of the candidate base station or the intelligent reflecting surface. Optionally, the current serving base station BS1, which receives the first measurement notification or the second measurement notification that includes the position information, may determine a receiving beam suitable for receiving a first beam or a second beam from a corresponding position (a position of the candidate base station or a position of the intelligent reflecting surface) based on the information, and provide a first measurement notification or a second measurement notification in an appropriate form to the user equipment UE accordingly, where the appropriate form includes a beam indication for the determined receiving beam. Alternatively, in a case that the user equipment itself may determine an appropriate receiving beam based on a position of a network side device, the current serving base station that receives the first measurement notification or the second measurement notification that include the above position information may transmit the position information to the user equipment, and the user equipment itself may determine a receiving beam suitable for receiving a first beam or a second beam from the corresponding position (the position of the candidate base station or the position of the intelligent reflecting surface) based on the information.

Except for the above difference of the candidate base station providing the measurement notification to the user equipment through the current serving base station of the user equipment and the receiving beam of the user equipment, the exemplary measurement process shown in FIG. 11 is substantially the same as the exemplary measurement process shown in FIG. 10, and is not repeated herein.

It should be noted that although not shown in FIGS. 10 and 11, the electronic device 100 used for the candidate base station BS2 may, for example, obtain the measurement result of the IRS assisted communication link based on measurement of a received first random access request and a second random access request by using the measurement result obtaining unit 110 (the measurement unit 113). As an example, a sum of measurement results of the two random access requests (such as a sum of two RSRPs) may be used as a measurement result of the entire communication link.

Next, as shown in FIG. 12, in a case that the measurement result of the communication link (measurement results of the first random access request and the second random access request) is higher than the threshold, the electronic device 100 used for the candidate base station BS2 may, for example, control, by using the user access enabling unit 120, the transceiver unit 130 to transmit a random access response to the UE to indicate that the UE may disconnect from the current serving base station BS1 and may access to the candidate base station BS2. Optionally, the handover between BS2 and the UE may be performed through messages (uplink “Message 3” and subsequent downlink “Message 4”) exchanged for conflict resolution. Optionally, BS2 may then transmit a handover completion notification to BS1 to inform BS1 that the UE handovers to BS2. As an example, the handover of the UE to BS2 may only performed in uplink, maintaining access to BS1 in downlink. Alternatively, the UE may handover to BS2 both in uplink and in downlink.

### 2.4 Exemplary Processes of Measurement after Handover

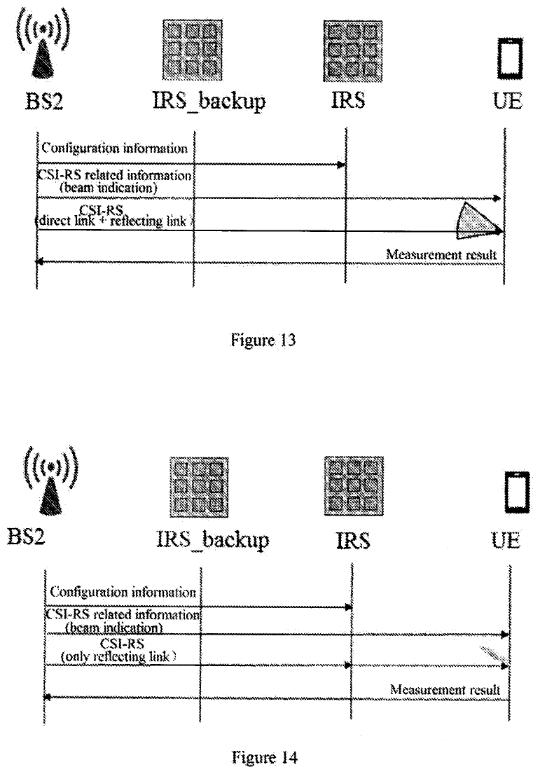

Next, with appropriate reference to the exemplary scenarios shown in FIGS. 1A and 1B, and referring to the exemplary information exchanges between a user equipment UE (such as UE2 in FIG. 1A or 1B), a base station BS2 (having the function of electronic device 100/implemented by electronic device 100) that has been a serving base station of the UE, and an intelligent reflecting surface (such as IRS in FIG. 1A or 1B) in the measurement after handover shown in FIGS. 13 to 14, exemplary processes of the electronic device 100 and various units of the electronic device 100 in the measurement after handover are described.

More specifically, FIGS. 13 and 14 show that, after the UE has handover to BS2, during the communication between the a UE and the BS2 with assistance of an IRS, an electronic device 100 used for the base station BS2 transmits a downlink reference signal such as CSI-RS to the UE (through the entire communication link assisted by the IRS or only through a reflecting link) and obtains a measurement result of the downlink reference signal from the US as a communication quality of the corresponding communication link (the entire communication link or the reflecting link), for example, by using the measurement result obtaining unit 110 and the transceiver unit 130. In the example shown in FIG. 13, the downlink reference signal is transmitted to the UE through the entire communication link assisted by the intelligent reflecting surface IRS. In the example shown in FIG. 14, the downlink reference signal is transmitted to the UE through only the reflecting link via the intelligent reflecting surface IRS.

Firstly, reference is made to FIG. 13. As shown in FIG. 13, for example, by using the IRS controlling unit 112 of the measurement result obtaining unit 110, the electronic device 100 used for the base station BS2 may generate configuration information for the IRS based on a real-time position of the user equipment UE and transmit the configuration information to the IRS, for example, through the transceiver unit 130, thereby performing real-time control on the IRS, ensuring that a first beam of the IRS to be directed to the UE and a second beam of the IRS to be directed to BS2, and ensuring that the reflecting link between the UE and the BS2 via the IRS is in an optimal state.

In addition, for example, through the measurement unit 113 of the measurement result obtaining unit 110, the electronic device 100 used for the base station BS2 may transmit information about a downlink reference signal such as CSI-RS to the UE, so that the UE may receive and measure the downlink reference signal based on the information.

As an example, the information about the downlink reference signal such as CSI-RS transmitted to the UE may include, but is not limited to, configuration information indicating the time-frequency resources used for transmitting the downlink reference signal. Optionally, the information about the downlink reference signal may further include beam information. The beam information is information related to a transmitting beam and/or a receiving beam of the downlink reference signal, and the UE may receive the downlink reference signal using a corresponding reception beam, for example, based on the information related to the transmitting beam and/or the receiving beam of the downlink reference signal. In the example shown in FIG. 13, the beam information, for example, indicates that the transmitting beam and/or the receiving beam of the downlink reference signal are wide beams, such as omnidirectional beams or beams covering at least both the IRS and the UE. That is, in the example shown in FIG. 13, the downlink reference signal is transmitted to the UE via both the direct link and the reflecting link.

Correspondingly, the UE receives and measures a downlink reference signal based on the information about the downlink reference signal, such as CSI-RS, received from BS2. For example, the UE receives and measures the downlink reference signal such as CSI-RS with a wide beam indicated by beam information in the information, and obtains a measurement result (such as RSRP). Subsequently, the UE transmits the measurement result to BS2.

In this way, the electronic device 100 used for the base station BS2 may obtain the communication quality of the IRS assisted communication link, and may determine another intelligent reflecting surface to assist the communication between BS2 and the UE when the communication quality does not meet a requirement.

For example, in a similar manner for controlling the IRS as shown in FIG. 13, the electronic device 100 may control a candidate intelligent reflecting surface IRS_backup (such as another intelligent reflecting surface located between BS2 and the UE that is determined by the IRS controlling unit 112) to go through a measurement process similar to the measurement process shown in FIG. 13, and measure a communication quality of a communication link between BS2 and the UE assisted by the IRS_backup. The electronic device 100 may replace the used intelligent reflecting surface with the IRS_backup in a case that the communication quality of the communication link assisted by the IRS_backup is higher than the previously measured communication quality of the communication link assisted by the IRS.

Next, reference is made to FIG. 14. The difference between the example of measurement after handover shown in FIG. 14 and the example of measurement after handover shown in FIG. 13 is that, the beam information in the information about the downlink reference signal such as CSI-RS transmitted by the electronic device 100 used for the base station BS2 to the UE indicates that the transmitting beam and/or the receiving beam of the downlink reference signal are narrow beams such as directional beams directing to the IRS, rather than wide beams such as omnidirectional beams or beams covering both the IRS and the UE. In the example shown in FIG. 14, the downlink reference signal is transmitted to the UE only via the reflecting link. Correspondingly, UE receives and measures the downlink reference signal such as CSI-RS based on the narrow beam indicated by the above beam information. Except for the above difference, the exemplary measurement process shown in FIG. 14 is substantially the same as the exemplary measurement process shown in FIG. 13, and is not repeated herein.

It should be noted that, although FIG. 13 and FIG. 14 show different examples of measurement after handover, the examples may be combined in appropriate situations. For example, after the communication quality of the current IRS assisted communication link is measured in the manner shown in FIG. 13, the communication quality of the communication link assisted by the candidate IRS_backup may be measured in a manner similar to the manner shown in FIG. 14, and vice versa, which are not repeated herein.

The electronic device 100 at the base station side according to the embodiments of the present disclosure is described. With the electronic device 100, a reflecting link between a UE and a candidate base stations via an IRS may be appropriately established, measured, controlled, and/or used, thereby more base stations (such as the candidate base station that is originally unable to effectively serve the UE but can effectively serve the UE with assistance of the IRS) being capable for serving the UE (such as but not limited to allocating transmission resources for the UE). This is especially beneficial in expanding the uplink coverage range of the UE in uplink handover, thereby improving user experience, especially improving user experience in uplink communication for which transmission resources/coverage ranges are particularly limited.

In the above description of the electronic device 100 at the base station side according to the embodiments of the present disclosure, in addition to the electronic device 100 at the base station side, the user equipment UE (such as UE2 shown in FIG. 1A or FIG. 1B, the UE shown in FIG. 1C, and the UE in the examples shown in FIGS. 4 to 14) of which the current serving base station is overloaded and for which the electronic device 100 is considered as a candidate base station for providing services is described. That is, according to the embodiments of the present disclosure, in addition to an electronic device at a base station side, an electronic device at a user side is also provided by the inventors. Hereinafter, based on the description of the electronic device at the base station side according to the embodiments of the present disclosure, description of an electronic device at a user side according to the embodiments of the present disclosure is provided, and unnecessary details are omitted.

### 3. CONFIGURATION EXAMPLES OF AN ELECTRONIC DEVICE AT A USER EQUIPMENT SIDE

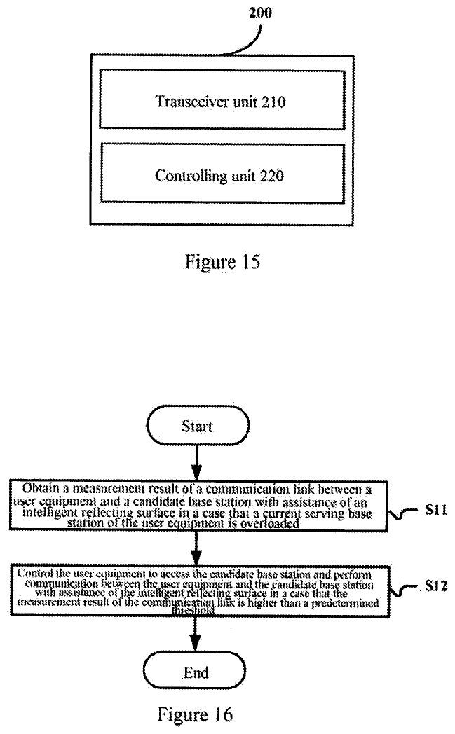

FIG. 15 is a block diagram showing a configuration example of an electronic device at a user equipment side according to an embodiment of the present disclosure. The electronic device may serve as the user device of which the current serving base station is overloaded as described in the configuration example of the electronic device at the base station side.

As shown in FIG. 15, an electronic device 200 may include a transceiver unit 210 and a controlling unit 220. The transceiver unit 210, for example, transmits information to a device other than the electronic device 200 and/or receives information from a device other than the electronic device 200 under the control of the controlling unit 220. In addition, although not shown in FIG. 15, the electronic device 200 may further include a storage unit.

All the units of the electronic device 200 may be included in processing circuitry. It should be noted that the electronic device 200 may include one processing circuitry or multiple processing circuitry. Further, the processing circuitry may include various discrete functional units to perform various functions and/or operations. It should be noted that the functional units may be physical entities or logical entities, and units with different titles may be implemented by the same physical entity.

The transceiver unit 210 may, under the control of the controlling unit 220, transmit an uplink signal for measuring a communication link between a user equipment and a candidate base station with assistance of an intelligent reflecting surface IRS, in a case that a current serving base station is overloaded. The communication link may be referred to as an intelligent reflecting surface assisted communication link, and it may include a direct link between the user equipment and the candidate base station and a reflecting link between the user equipment and the candidate base station via the intelligent reflecting surface. In addition, the controlling unit 220 may, for example, control the transceiver unit 210 to access the candidate base station through interaction with the candidate base station and perform communication between the user equipment and the candidate base station with assistance of the intelligent reflecting surface, in a case that a measurement result of the communication link is higher than a threshold.

The electronic device 200 may use the controlling unit 210 to control the transceiver unit 220 to perform, through various appropriate manners or processes, such as but not limited to information and/or signal interactions with the candidate base station, the current serving base station and/or the intelligent reflecting surface, so as to perform the above-mentioned transmission of the uplink signal for measuring the IRS assisted communication link and the above-mentioned process of handover to the candidate base station based on the measurement result (the IRS assisted handover process).

As an example, a situation in which a current serving base station is overloaded and unable to allocate uplink resources for a user equipment may be considered. In this situation, in a case that the electronic device 200 serves as a user equipment transmits an uplink scheduling request to the overloaded current serving base station, the intelligent reflecting surface assisted handover process may be initiated in response to a request from the current serving base station receiving the uplink scheduling request to the candidate base station or a random access request from the electronic device 200 serving as the user equipment to the candidate base station due to that the electronic device 200 cannot obtain an uplink resource permission from the current serving base station.

In one example, the handover process may be initiated in a dynamical manner (dynamic handover). When the current serving base station, which is overloaded, receives an uplink scheduling request from the electronic device 200 serving as the user equipment, the current serving base station transmits relevant information about the user equipment and a measurement request for the IRS assisted communication link between the user equipment and the candidate base station to the candidate base station, so that the candidate base station controls measurement of the communication link based on the relevant information of the user equipment in response to the measurement request.

In this example, the electronic device 200 as the user equipment may use the controlling unit 210 to control the transceiver unit 220 to transmit an uplink reference signal to the candidate base station through a communication link including a direct link between the user equipment and the candidate base station and a reflecting link between the user equipment and the candidate base station via the intelligent reflecting surface, so that the candidate base station may obtain a measurement result of the communication link based on a measurement result of the received uplink reference signal.

As an example, through the information exchange process described above with reference to FIG. 4, the IRS assisted handover process may be initiated in response to a measurement request to the candidate base station from the current serving base station that receives, in a case of being overload, the uplink scheduling request from the user equipment. More specifically, a measurement process for the IRS assisted communication link between the user equipment and the candidate base station as described with reference to FIG. 5 or FIG. 7 is to be initiated. The electronic device 200, as the user equipment, may use the controlling unit 210 to control the transceiver unit 220 to perform all the functions or processes of the UE described in the example shown in FIG. 4, which is not repeated herein.

In addition, after the measurement process for the IRS assisted communication link between the user equipment and the candidate base station is started, as an example, the electronic device 200 as the user equipment may use the controlling unit 210 to control the transceiver unit 220 to perform all the functions or processes of the UE in the exemplary measurement process described with reference to FIG. 5 or FIG. 7, which is not repeated herein.

In addition, after performing the measurement process of the IRS assisted communication link between the user equipment and the candidate base station, the electronic device 200 may use the controlling unit 210 to control the transceiver unit 220 to, based on a RRC reconfiguration instruction transmitting by the current serving base station in a case of a measurement result higher than a threshold, disconnect (in uplink and/or downlink) from the current serving base station and access (in uplink and/or downlink) to the candidate base station. As an example, the handover of the electronic device 200 may be, for example, limited to only an uplink handover (access to the candidate base station in uplink), and the electronic device 200 remains access to the current serving base station in downlink in a case of decoupling of uplink and downlink. Alternatively, the electronic device 200 may handover to the candidate base station both in uplink and in downlink. Then, the electronic device 200 may use the controlling unit 210 to control the transceiver unit 220 to perform communication between the user equipment and the candidate base station that is currently a serving base station of the user equipment with assistance of the intelligent reflecting surface.

In one example, the handover process may be initiated in a semi-static manner (semi-static handover). The electronic device, as the user equipment, uses the controlling unit 210 to control the transceiver unit 220 to transmit a random access request to the candidate base station in a case that the electronic device cannot obtain uplink resources from the overloaded current serving base station, so that the candidate base station controls measurement of the communication link based on the received random access request.

As an example, through the information exchange process described above with reference to FIGS. 8 and 9, the electronic device serving as the user equipment may use the controlling unit 210 to control the transceiver unit 220 to transmit a random access request to the candidate base station due to that the user equipment cannot obtain uplink transmission resource permission after transmitting an uplink scheduling request to the overloaded current serving base station, thereby initiating the IRS assisted handover process. More specifically, a measurement process for the IRS assisted communication link between the user equipment and the candidate base station as described with reference to FIG. 10 or FIG. 11 is to be initiated in a case that the direct link between the user equipment and the candidate base station does not meet the requirement. The electronic device 200, as the user equipment, may use the controlling unit 210 to control the transceiver unit 220 to perform all the functions or processes of the UE described in the examples shown in FIGS. 8 and 9, which is not repeated herein.

In addition, for example, after the measurement process of the IRS assisted communication link between the user equipment and the candidate base station is initiated, after the exemplary processes described with reference to FIGS. 8 and 9, due to that the direct link between the user equipment and the candidate base station does not meet the requirement, the electronic device 200 as the user equipment may use the controlling unit 210 to control the transceiver unit 220 to perform all the functions or processes of the UE in the exemplary measurement process described with reference to FIG. 10 or 11, which is only briefly described.

In summary, in a case that the intelligent reflecting surface is not used, the electronic device 200 as the user equipment may use the controlling unit 210 to control the transceiver unit 220 to receive a first downlink reference signal, such as a first SSB, transmitted by the candidate base station in sequence with multiple first beams (that is, performing a first SSB beam scan), determine an uplink beam, for example, corresponding to one (such as a first beam with a highest RSRP of the received signal) of the multiple first beams, and transmit a first random access request to the candidate base station using the determined uplink beam. Such a first random access request is transmitted to the candidate base station only through the direct link. In addition, the electronic device 200 may further use the controlling unit 210 to control the transceiver unit 220 to receive a second downlink reference signal, such as a second SSB, transmitted from the candidate base station that is reflected by the intelligent reflecting surface in sequence with multiple second beams (that is, performing a second SSB beam scan), determine an uplink beam, for example, corresponding to one (such as a second beam with a highest RSRP of the received signal) of the multiple second beams, and transmit a second random access request to the intelligent reflecting surface with the determined uplink beam for the intelligent reflecting surface to reflect to the candidate base station. Such a second random access request is transmitted to the candidate base station only through a reflecting link via the IRS.

Correspondingly, the candidate base station may measure the first random access request transmitted only through the direct link and the second random access request transmitted only through the reflecting link via the IRS to obtain the measurement result of the IRS assisted communication link. As an example, the candidate base station determines a sum of the measurement results (such as a sum of two RSRPs) of the two random access requests as the measurement result of the entire communication link.

In the above measurement process, the first SSB and the second SSB transmitted by the candidate base station may be different or identical to each other. In an example, the first SSB and the second SSB are different from each other, and the electronic device 200 as the user equipment may determine the first SSB beam scan and the second SSB beam scan as SSB beam scans of two candidate base stations and process the SSB beam scans respectively.

In another example, the first SSB and the second SSB are identical to each other. Thus, optionally, the electronic device 200 as the user equipment may obtain a measurement notification from the candidate base station through the current serving base station before each of the beam scans, so that the electronic device 200 may receive the SSB based on the instructions in the measurement notifications. Each of the measurement notifications, for example, may indicate with minimal information that the network side is to perform a SSB beam scan (the first SSB beam scan via the direct link or the second SSB beam scan using the IRS), facilitating the electronic device 200 as the user equipment determining an uplink beam corresponding to a (downlink) beam (one of the first beam or the second beam) for each of the two beam scans and transmitting a corresponding random access request using the determined uplink beam.

In the above example, the electronic device 200 as the user equipment may not obtain measurement notifications from the candidate base station or may obtain measurement notifications containing only minimum information indicating that a SSB beam scan is to be performed, and may use an omnidirectional beam as a receiving beam for the SSB beam scan.

In an alternative example, the measurement notifications, obtained by the electronic device 200, as the user equipment, from the candidate base station through the current serving base station before each of the beam scans, may include more information (such as but not limited to the first information about the first downlink reference signal and the second information about the second downlink reference signal). The information is beneficial for the user equipment to determine an appropriate receiving beam for receiving the downlink reference signal such as SSB, so that the user equipment may use, for the SSB beam scan, a corresponding narrow beam (rather than an omnidirectional beam) as the receiving beam.

More specifically, the electronic device 200 as the user equipment may use the controlling unit 210 to control the transceiver unit 220 to obtain first information about the first downlink reference signal provided from the candidate base station through the current serving base station where the first information includes relevant information about the candidate base station, and obtain second information about the second downlink reference signal provided from the candidate base station through the current serving base station where the second information includes relevant information about the intelligent reflecting surface.

As an example, in a case that the electronic device 200, as the user equipment, can determine by itself an appropriate receiving beam based on a position of a network side device, the relevant information of the candidate base station or the relevant information of the intelligent reflecting surface received by the electronic device 200 via the current serving base station may be, for example, position information of the candidate base station or position information of the intelligent reflecting surface. Alternatively, in a case that the electronic device 200, as the user equipment, cannot determine by itself an appropriate receiving beam based on a position of a network side device, the relevant information of the candidate base station or the relevant information of the intelligent reflecting surface received by the electronic device 200 via the current serving base station may be information in an appropriate form converted by the current serving base station, such as but not limited to a beam indication of a receiving beam (suitable for receiving the first beam or the second beam of the candidate base station or the intelligent reflecting surface).

In addition, after performing the measurement process of the IRS assisted communication link between the user equipment and the candidate base station, the electronic device 200 as the user equipment may use the controlling unit 210 to control the transceiver unit 220 to receive a random access response to the user equipment that is transmitted from the candidate base station after determining the measurement result of the communication link to be higher than the threshold based on measurement results of the received first and second random access requests. The electronic device 200 as the user equipment may access (in uplink and/or downlink) to the candidate base station based on the random access response. The electronic device 200 may use the controlling unit 210 to control the transceiver unit 220 to perform all the functions or processes of the UE in the exemplary process described with reference to FIG. 12, which is not repeated herein. As an example, the handover of the electronic device 200 may be, for example, limited to only an uplink handover (access to the candidate base station in uplink), and the electronic device 200 remains access to the current serving base station in downlink in a case of decoupling of uplink and downlink. Alternatively, the electronic device 200 may handover to the candidate base station both in uplink and in downlink.

Then, the electronic device 200 may use the controlling unit 210 to control the transceiver unit 220 to perform communication between the user equipment and the candidate base station that is currently a serving base station of the user equipment with assistance of the intelligent reflecting surface.

In this case, the electronic device 200 as the user equipment may use the controlling unit 210 to control the transceiver unit 220 to, during the communication between the user equipment and the base station (that is, the candidate base station that has become the serving base station of the user equipment) with assistance of the intelligent reflecting surface, measure the downlink reference signal transmitted by the base station to the user equipment, and report a measurement result of the downlink reference signal to the base station as the communication quality of the communication link (measurement after handover), so that the base station may change the used intelligent reflecting surface when necessary.

More specifically, the electronic device 200 as the user equipment may use the controlling unit 210 to control the transceiver unit 220 to perform all the functions or processes of the UE in the exemplary process of measurement after handover described with reference to FIG. 13 or FIG. 14. Herein, only a brief description is provided and details are omitted.

In summary, the electronic device 200 as the user equipment may use the controlling unit 210 to control the transceiver unit 220 to, during the communication between the user equipment and the base station (that is, the candidate base station that has become the serving base station of the user equipment) with assistance of the intelligent reflecting surface, measure the downlink reference signal such as CSI-RS transmitted by the base station to the user equipment through the entire IRS assisted communication link or specifically only through the reflecting link via the intelligent reflecting surface, and report the measurement result of the downlink reference signal to the base station as the communication quality of the corresponding communication link, that is, as a communication quality of the entire IRS assisted communication link or as a communication quality of the reflecting link via the intelligent reflecting surface.

Optionally, the electronic device 200 as the user equipment may use the controlling unit 210 to control the transceiver unit 220 to receive information about a downlink reference signals such as CSI-RS from the candidate base station, and then to receive and measure the downlink reference signal based on the information. As an example, the information about the downlink reference signal such as CSI-RS received from the candidate base station may include, but is not limited to, configuration information indicating time-frequency resources used for transmitting the downlink reference signal.

Preferably, the information about the downlink reference signal received from the candidate base station may include beam information. The beam information is information related to a transmitting beam and/or a receiving beam of the downlink reference signal. The electronic device 200 as the user equipment may receive the downlink reference signal with a corresponding receiving beam based on indication of the beam information. In the example in which the base station transmits the downlink reference signal to the user equipment through the entire IRS assisted communication link, the beam information, for example, indicates that the transmitting beam and/or the receiving beam of the downlink reference signal are wide beams, such as omnidirectional beams or beams covering at least both the IRS and the UE. In the example in which the base station transmits the downlink reference signal to the user equipment only through the reflecting link via the intelligent reflecting surface, the beam information indicates that the transmitting beam and/or the receiving beam of the downlink reference signal are narrow beams, such as directional beams directing to the IRS.

The electronic device 200 at the user equipment side according to the embodiments of the present disclosure is described. With interactions between the electronic device 200 and the serving base station, the candidate base station, and/or the intelligent reflecting surface, a reflecting link between a UE and a candidate base stations via an IRS may be appropriately established, measured, controlled, and/or used by the candidate base station, thereby more base stations (such as the candidate base station that is originally unable to effectively serve the UE but can effectively serve the UE with assistance of the IRS) being capable for serving the UE (such as but not limited to allocating transmission resources for the UE). This is especially beneficial in expanding the uplink coverage range of the UE in uplink handover, thereby improving user experience, especially improving user experience in uplink communication for which transmission resources/coverage ranges are particularly limited.

### 4. METHOD EMBODIMENTS

Corresponding to the above device embodiments, the following method embodiments are provided according to the present disclosure.

### (Method Embodiments at a Base Station Side)

FIG. 16 is a flowchart showing an exemplary process of a method for wireless communication at a base station side according to a first embodiment of the present disclosure.

As shown in FIG. 16, in step S11, in a case that a current serving base station of a user equipment is overloaded, a measurement result of a communication link between the user equipment and a candidate base station with assistance of an intelligent reflecting surface is obtained.

Next, in step S12, in a case that the measurement result of the communication link is higher than a threshold, the user equipment is enabled to access the candidate base station and perform communication between the user equipment and the candidate base station with assistance of the intelligent reflecting surface.

Although not shown in FIG. 16, the exemplary process shown in FIG. 16 may be started or initiated by a dynamic handover or a semi-static handover.

In a first example, the exemplary process shown in FIG. 16 may be started or initiated by a dynamic handover.

For example, although not shown in FIG. 16, before step S11 and/or in step S11, relevant information of the user equipment and a measurement request for the communication link may be received, which are transmitted to the candidate base station by the current serving base station when the current serving base station receives, in a case of being overloaded, an uplink scheduling request from the user equipment. Next, in step S11, according to the measurement request, measurement on the communication link may be controlled based on the relevant information, so as to obtain the measurement result.

Optionally, in step S11, the following processing may be further included: determining, based on the relevant information, an intelligent reflecting surface or multiple intelligent reflecting surfaces that can be cascaded between the user equipment and the candidate base station to assist communication.

Optionally, in step S11, the following processing may be further included: controlling a first beam of the intelligent reflecting surface to be directed to the user equipment and/or a second beam of the intelligent reflecting surface to be directed to the candidate base station, to establish a reflecting link between the user equipment and the candidate base station via the intelligent reflecting surface.

Optionally, in step S11, the following processing may be further included: measuring an uplink reference signal transmitted by the user equipment and received via the communication link including the reflecting link and a direct link between the user equipment and the candidate base station; and obtaining the measurement result of the communication link based on a measurement result of the uplink reference signal.

In addition, optionally, in step S12, the following processing may be further included: providing the measurement result of the communication link to the current serving base station of the user equipment, so that the current serving base station instructs the user equipment to disconnect from the current serving base station and access to the candidate base station in the case that the measurement result is higher than the threshold.

In a second example, the exemplary process shown in FIG. 16 may be started or initiated by a semi-static handover.

For example, although not shown in FIG. 16, before step S11 and/or in step S11, a random access request, which is transmitted by the user equipment to the candidate base station in a case that the user equipment cannot obtain uplink resources from the overloaded current serving base station, may be received. Next, in step S11, measurement on the communication link may be controlled based on the received random access request.

Optionally, in step S11, the following processing may be further included: in a case that the intelligent reflecting surface is not used, transmitting a first downlink reference signal sequentially with multiple first beams, and receiving a first random access request transmitted by the user equipment to the candidate base station with a beam corresponding to one of the multiple first beams; and transmitting a second downlink reference signal to the intelligent reflecting surface and control the intelligent reflecting surface to reflect the second downlink reference signal sequentially with multiple second beams, and receiving a second random access request reflected by the intelligent reflecting surface and transmitted by the user equipment to the intelligent reflecting surface with a beam corresponding to one of the multiple second beams.

Optionally, in step S11, the following processing may be further included: providing, through the current serving base station of the user equipment, first information about the first downlink reference signal to the user equipment, where the first information includes relevant information about the candidate base station; and providing, through the current serving base station of the user equipment, second information about the second downlink reference signal to the user equipment, where the second information includes relevant information about the intelligent reflecting surface.

Optionally, in step S11, the following processing may be further included: measuring the received first random access request and the received second random access request to obtain the measurement result of the communication link. In addition, optionally, in step S12, the following processing may be further included: transmitting a random access response to the user equipment in a case that the measurement result of the communication link is higher than the threshold.

In addition, although not shown in FIG. 16, additional processing of measurement after handover may be further included after the exemplary process shown in FIG. 16.

Optionally, the following processing of measurement after handover may be included: during the communication between the user equipment and the candidate base station with assistance of the intelligent reflecting surface, transmitting a downlink reference signal to the user equipment, and obtaining a measurement result of the downlink reference signal from the user equipment as a communication quality of the communication link.

In addition, optionally, the following processing of measurement after handover may be included: during the communication between the user equipment and the candidate base station with assistance of the intelligent reflecting surface, transmitting a downlink reference signal to the user equipment only through a reflecting link via the intelligent reflecting surface, and obtaining a measurement result of the downlink reference signal from the user equipment as a communication quality of the reflecting link.

In the above processing of measurement after handover, optionally, information about the downlink reference signal is transmitted to the user equipment. The information at least includes information related to a transmitting beam and/or a receiving beam of the downlink reference signal.

According to the embodiments of the present disclosure, the subject performing the above method may be an electronic device at the base station side according to the embodiments of the present disclosure. Therefore, all the embodiments of the electronic device at the base station side mentioned above are applicable, and are not repeated herein.

### (Method Embodiments at a User Equipment Side)

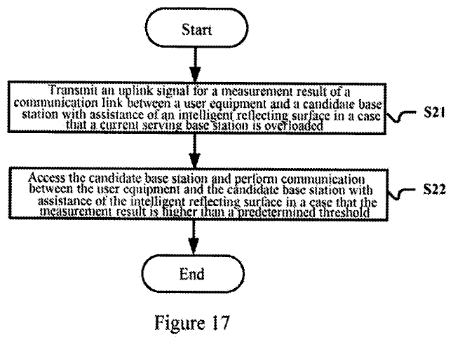

FIG. 17 is a flowchart showing an exemplary process of a method for wireless communication at a user equipment side according to an embodiment of the present disclosure.

As shown in FIG. 17, in step S21, in a case that a current serving base station is overloaded, an uplink signal is transmitted for measuring a communication link between a user equipment and a candidate base station with assistance of an intelligent reflecting surface.

Next, in step S22, in a case that a measurement result of the communication link is higher than a threshold, the candidate base station is accessed and communication between the user equipment and the candidate base station is performed with assistance of the intelligent reflecting surface.

Although not shown in FIG. 17, the exemplary process shown in FIG. 17 may be started or initiated by a dynamic handover or a semi-static handover.

In a first example, the exemplary process shown in FIG. 17 may be started or initiated by a dynamic handover.

For example, although not shown in FIG. 17, before step S21 and/or in step S21, an uplink scheduling request may be transmitted to the overloaded current serving base station, so that the current serving base station transmits relevant information of the user equipment and a measurement request for the communication link to the candidate base station, so that the candidate base station may start or control the measurement of the communication link based on the measurement request.

Optionally, in step S21, the following processing may be further included: transmitting an uplink reference signal to the candidate base station via the communication link including a direct link and a reflecting link through the intelligent reflecting surface between the user equipment and the candidate base station, so that the candidate base station obtains the measurement result of the communication link based on a measurement result of the received uplink reference signal.

Optionally, in step S22, the following processing may be further included: disconnecting from the current serving base station and accessing to the candidate base station based on an instruction transmitted from the current serving base station in the case that the measurement result of the communication link is higher than the threshold.

In a second example, the exemplary process shown in FIG. 17 may be started or initiated by a semi-static handover.

For example, although not shown in FIG. 17, before step S21 and/or in step S21, in a case of being unable to obtain uplink resources from the overloaded current serving base station, a random access request may be transmitted to the candidate base station, so that the candidate base station may start or control measurement of the communication link based on the received random access request.

Optionally, in step S21, the following processing may be further included: in a case that the intelligent reflecting surface is not used, receiving a first downlink reference signal transmitted by the candidate base station sequentially with multiple first beams, and transmitting a first random access request to the candidate base station with a beam corresponding to one of the multiple first beams; and receiving a second downlink reference signal from the candidate base station reflected by the intelligent reflecting surface sequentially with multiple second beams, and transmitting a second random access request to the intelligent reflecting surface with a beam corresponding to one of the multiple second beams for the intelligent reflecting surface to reflect the second random access request to the candidate base station.

Optionally, in step S21, the following processing may be further included: obtaining first information about the first downlink reference signal provided by the candidate base station through the current serving base station, where the first information includes relevant information about the candidate base station; and obtaining second information about the second downlink reference signal provided by the candidate base station through the current serving base station, where the second information includes relevant information about the intelligent reflecting surface.

In addition, optionally, in step S21, the following processing may be further included: receiving a random access response transmitted by the candidate base station to the user equipment in a case that the candidate base station determines that the measurement result of the communication link is higher than the threshold based on a measurement result of the received first random access request and the received second random access request.

In addition, although not shown in FIG. 17, additional processing of measurement after handover may be further included after the exemplary process shown in FIG. 17.

Optionally, the following processing of measurement after handover may be included: during the communication between the user equipment and the candidate base station with assistance of the intelligent reflecting surface, measuring a downlink reference signal transmitted by the candidate base station to the user equipment, and reporting a measurement result of the downlink reference signal to the candidate base station as a communication quality of the communication link.

In addition, optionally, the following processing of measurement after handover may be included: during the communication between the user equipment and the candidate base station with assistance of the intelligent reflecting surface, measuring a downlink reference signal transmitted by the candidate base station to the user equipment only through a reflecting link via the intelligent reflecting surface, and reporting a measurement result of the downlink reference signal to the candidate base station as a communication quality of the reflecting link via the intelligent reflecting surface.

In the above processing of measurement after handover, optionally, information about the downlink reference signal is received from the candidate base station. The information at least includes information related to a transmitting beam and/or a receiving beam of the downlink reference signal.

According to the embodiments of the present disclosure, the subject performing the above method may be an electronic device at the user equipment side according to the embodiments of the present disclosure. Therefore, all the embodiments of the electronic device at the user equipment side mentioned above are applicable, and are not repeated herein.

### 5. APPLICATION EXAMPLES

The technology according to the present disclosure may be applicable to various products.

For example, the electronic device 100 may be implemented at a base station side. In a case that the electronic device is implemented at a base station side, the electronic device may be implemented as various base stations, such as a macro eNB and a small eNB, and may be implemented as any type of gNB (a base station in a 5G system). The small eNB may be an eNB, such as a pico eNB, a micro eNB, and a home (femto) eNB, which covers a cell smaller than a macro cell. Alternatively, the base station may be implemented as any other type of base station, such as a NodeB and a base transceiver station (BTS). The base station may include: a body (which is also referred to as a base station device) configured to control wireless communications, and one or more remote wireless heads (RRHs) arranged in a different place from the body.

The electronic device 100 at the base station side may further be implemented as various TRPs. The TRPs may have transmitting and receiving functions, such as receiving information from a user equipment and a base station device and transmitting information to a user equipment and a base station device. In a typical example, the TRPs may provide services to a user equipment and is controlled by a base station device. Furthermore, the TRPs may have a structure similar to the structure of the base station device, or the TRPs may only have a structure related to transmitting and receiving information in the base station device.

In addition, the electronic device 200 may be implemented at a user equipment side. In a case that the electronic device is implemented at a user equipment side, for example, is implemented as a user equipment, the electronic device may be implemented as various user equipments. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that performs machine-to-machine (M2M) communication. In addition, the user equipment may be a wireless communication module (such as an integrated circuit module including a single chip) installed on each of the above-mentioned user equipments.

[Application Examples about Base Station]

### First Application Example

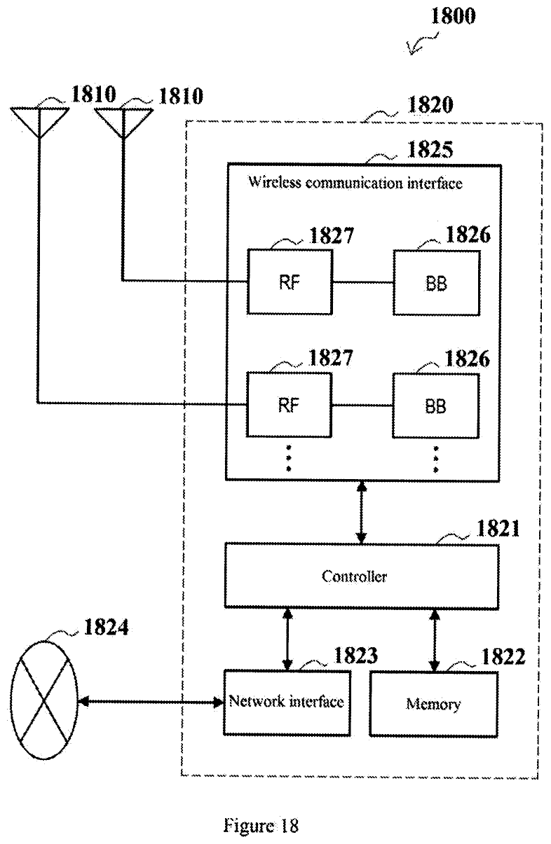

FIG. 18 is a block diagram showing a first example of a schematic configuration of an eNB to which the technology of the present disclosure may be applied. An eNB 1800 includes one or more antennas 1810 and a base station device 1820. The base station device 1820 and each of the antennas 1810 may be connected to each other via an RF cable.

Each of the antennas 1810 includes a single or multiple antenna elements (such as multiple antenna elements included in a multiple-input multiple-output (MIMO) antenna), and is used for the base station device 1820 to transmit and receive wireless signals. As shown in FIG. 18, the eNB 1800 may include multiple antennas 1810. For example, the multiple antennas 1810 may be compatible with multiple frequency bands used by the eNB 1800. Although FIG. 18 shows an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be, for example, a CPU or a DSP, and manipulate various functions of a higher layer of the base station device 1820. For example, the controller 1821 generates a data packet based on data in a signal processed by the wireless communication interface 1825, and transmits the generated packet via the network interface 1823. The controller 1821 may bundle data from multiple baseband processors to generate a bundled packet, and transfer the generated bundled packet. The controller 1821 may have a logical function for performing control such as radio resource control, radio bearer control, mobility management, admission control, and scheduling. This control may be executed in conjunction with nearby eNBs or core network nodes. The memory 1822 includes an RAM and an ROM, and stores programs executed by the controller 1821 and various types of control data (such as a terminal list, transmission power data, and scheduling data).

The network interface 1823 is a communication interface for connecting the base station device 1820 to a core network 1824. The controller 1821 may communicate with a core network node or another eNB via the network interface 1823. In this case, the eNB 1800 and the core network node or other eNBs may be connected to each other through a logical interface (such as an SI interface and an X2 interface). The network interface 1823 may also be a wired communication interface, or a wireless communication interface for a wireless backhaul line. If the network interface 1823 is a wireless communication interface, the network interface 1823 may use a higher frequency band for wireless communications than the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via an antenna 1810. The wireless communication interface 1825 may generally include, for example, a baseband (BB) processor 1826 and an RF circuit 1827. The BB processor 1826 may perform, for example, encoding/decoding, modulation/demodulation, and multiplexing/demultiplexing, and perform various types of signal processing of layers (such as L1, medium access control (MAC), radio link control (RLC), and packet data convergence protocol (PDCP)). Instead of the controller 1821, the BB processor 1826 may have a part or all of the above-mentioned logical functions. The BB processor 1826 may be a memory storing a communication control program, or a module including a processor and related circuits configured to execute the program. The function of the BB processor 1826 may be changed by updating the program. The module may be a card or a blade inserted into a slot of the base station device 1820. Alternatively, the module may be a chip mounted on a card or blade. Meanwhile, the RF circuit 1827 may include, for example, a mixer, a filter, and an amplifier, and transmit and receive a wireless signal via the antenna 1810.

As shown in FIG. 18, the wireless communication interface 1825 may include multiple BB processors 1826. For example, the multiple BB processors 1826 may be compatible with multiple frequency bands used by the eNB 1800. As shown in FIG. 18, the wireless communication interface 1825 may include multiple RF circuits 1827. For example, the multiple RF circuits 1827 may be compatible with multiple antenna elements. Although FIG. 18 shows an example in which the wireless communication interface 1825 includes multiple BB processors 1826 and multiple RF circuits 1827, the wireless communication interface 1825 may also include a single BB processor 1826 or a single RF circuit 1827.

In the eNB 1800 shown in FIG. 18, the functions of the measurement result obtaining unit 110 and the user access enabling unit 220 in the electronic device 100 described with reference to FIG. 2 may be implemented by the controller 1821 (and optionally some modules in the wireless communication interface 1825). For example, the controller 1821 may perform functions or at least some functions of corresponding units by executing instructions stored in the memory 1822. The transceiver unit 130 in the electronic device 100 may be implemented by the wireless communication interface 1825 (for example, under the control of the controller 1821). In addition, the storage unit not shown in the electronic device 100 may be implemented by the memory 1822.

### Second Application Example

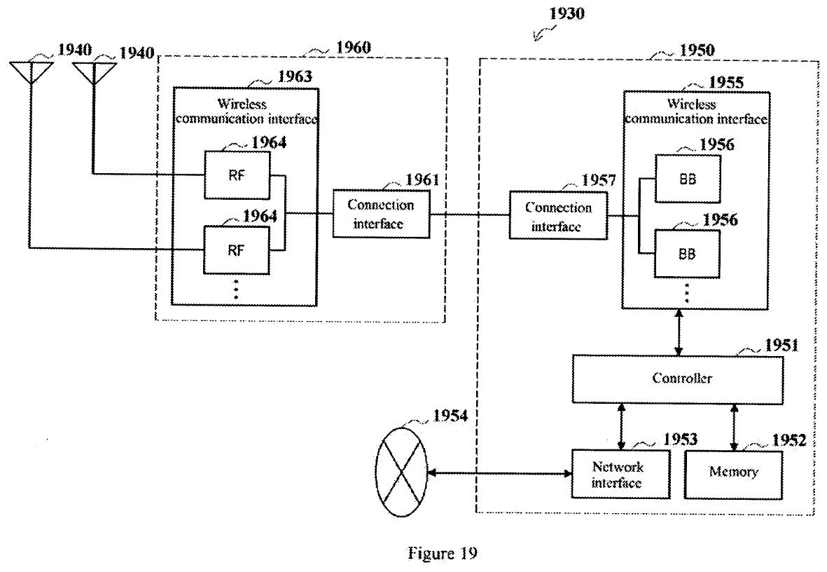

FIG. 19 is a block diagram showing a second example of a schematic configuration of an eNB to which the technology of the present disclosure may be applied. An eNB 1930 includes one or more antennas 1940, a base station device 1950, and an RRH 1960. The RRH 1960 and each antenna 1940 may be connected to each other via an RF cable. The base station device 1950 and the RRH 1960 may be connected to each other via a high-speed line such as an optical fiber cable.

Each of the antennas 1940 includes a single or multiple antenna elements (such as multiple antenna elements included in a MIMO antenna) and is used for the RRH 1960 to transmit and receive a wireless signal. As shown in FIG. 19, the eNB 1930 may include multiple antennas 1940. For example, the multiple antennas 1940 may be compatible with multiple frequency bands used by the eNB 1930. Although FIG. 19 shows an example in which the eNB 1930 includes multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 as described with reference to FIG. 18.

The wireless communication interface 1955 supports any cellular communication scheme (such as LTE and LTE-Advanced), and provides wireless communications to a terminal located in a sector corresponding to the RRH 1960 via the RRH 1960 and the antenna 1940. The wireless communication interface 1955 may generally include, for example, a BB processor 1956. The BB processor 1956 is the same as the BB processor 1826 described with reference to FIG. 17 except that the BB processor 1956 is connected to the RF circuit 1964 of the RRH 1960 via the connection interface 1957. As shown in FIG. 19, the wireless communication interface 1955 may include multiple BB processors 1956. For example, the multiple BB processors 1956 may be compatible with multiple frequency bands used by the eNB 1930. Although FIG. 19 shows an example in which the wireless communication interface 1955 includes multiple BB processors 1956, the wireless communication interface 1955 may also include a single BB processor 1956.

The connection interface 1957 is an interface for connecting the base station device 1950 (wireless communication interface 1955) to the RRH 1960. The connection interface 1957 may also be a communication module for communication in the above-mentioned high-speed line that connects the RRH 1960 to the base station device 1950 (wireless communication interface 1955).

The RRH 1960 includes a connection interface 1961 and a wireless communication interface 1963.

The connection interface 1961 is an interface for connecting the RRH 1960 (wireless communication interface 1963) to the base station device 1950. The connection interface 1961 may also be a communication module for communication in the above-mentioned high-speed line.

The wireless communication interface 1963 transmits and receives wireless signals via the antenna 1940. The wireless communication interface 1963 may generally include, for example, an RF circuit 1964. The RF circuit 1964 may include, for example, a mixer, a filter, and an amplifier, and transmit and receive wireless signals via the antenna 1940. As shown in FIG. 19, the wireless communication interface 1963 may include multiple RF circuits 1964. For example, the multiple RF circuits 1964 may support multiple antenna elements. Although FIG. 19 shows an example in which the wireless communication interface 1963 includes multiple RF circuits 1964, the wireless communication interface 1963 may also include a single RF circuit 1964.

In the eNB 1930 shown in FIG. 19, the functions of the measurement result obtaining unit 110 and the user access enabling unit 220 in the electronic device 100 described with reference to FIG. 2 may be implemented by the controller 1951 (optionally and the wireless communication interface 1955 and some modules in the wireless communication interface 1963). For example, the controller 1951 may perform functions or at least some functions of corresponding units by executing instructions stored in the memory 1952. The transceiver unit 130 in the electronic device 100 may be implemented by the wireless communication interface 1955 and the wireless communication interface 1963 (for example, under the control of the controller 1821). In addition, the storage unit not shown in the electronic device 100 may be implemented by the memory 1952.

[Application Example about User Equipment]

### First Application Example

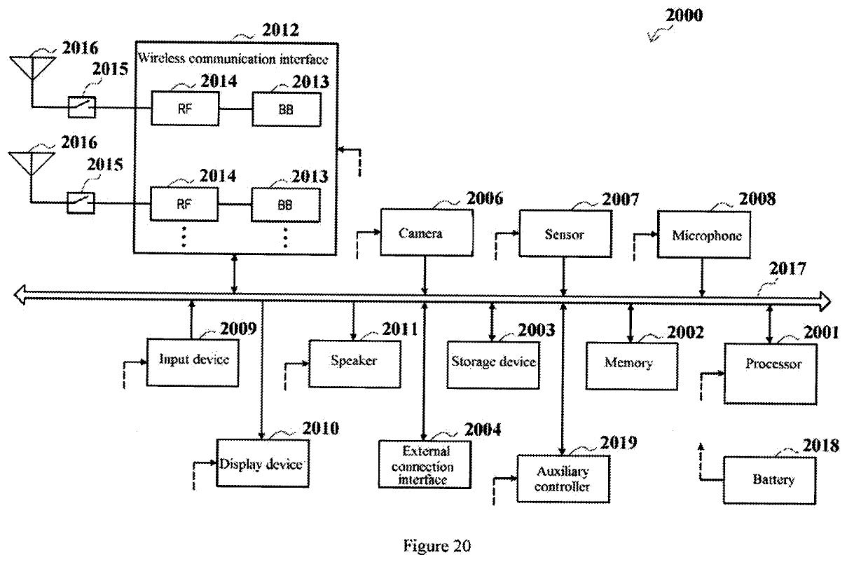

FIG. 20 is a block diagram showing an example of a schematic configuration of a smart phone 2000 to which the technology of the present disclosure may be applied. The smart phone 2000 includes a processor 2001, a memory 2002, a storage device 2003, an external connection interface 2004, a camera device 2006, a sensor 2007, a microphone 2008, an input device 2009, a display device 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on a chip (SoC), and controls the functions of the application layer and other layers of the smart phone 2000. The memory 2002 includes an RAM and an ROM, and stores data and programs executed by the processor 2001. The storage device 2003 may include a storage medium such as a semiconductor memory and a hard disk. The external connection interface 2004 is an interface for connecting an external device (such as a memory card and a universal serial bus (USB) device) to the smart phone 2000.

The camera device 2006 includes an image sensor (such as a charge coupled device (CCD) and a complementary metal oxide semiconductor (CMOS)), and generates a captured image. The sensor 2007 may include a group of sensors, such as a measurement sensor, a gyroscope sensor, a geomagnetic sensor, and an acceleration sensor. The microphone 2008 converts sound inputted to the smart phone 2000 into an audio signal. The input device 2009 includes, for example, a touch sensor, a keypad, a keyboard, a button, or a switch configured to detect a touch on a screen of the display device 2010, and receives an operation or information input from a user. The display device 2010 includes a screen (such as a liquid crystal display (LCD) and an organic light emitting diode (OLED) display), and displays an output image of the smart phone 2000. The speaker 2011 converts an audio signal outputted from the smart phone 2000 into sound.

The wireless communication interface 2012 supports any cellular communication scheme (such as LTE and LTE-Advanced), and performs wireless communication. The wireless communication interface 2012 may generally include, for example, a BB processor 2013 and an RF circuit 2014. The BB processor 2013 may perform, for example, encoding/decoding, modulation/demodulation, and multiplexing/demultiplexing, and perform various types of signal processing for wireless communications. Further, the RF circuit 2014 may include, for example, a mixer, a filter, and an amplifier, and transmit and receive wireless signals via the antenna 2016. The wireless communication interface 2012 may be a chip module on which the BB processor 2013 and the RF circuit 2014 are integrated. As shown in FIG. 20, the wireless communication interface 2012 may include multiple BB processors 2013 and multiple RF circuits 2014. Although FIG. 20 shows an example in which the wireless communication interface 2012 includes multiple BB processors 2013 and multiple RF circuits 2014, the wireless communication interface 2012 may also include a single BB processor 2013 or a single RF circuit 2014.

In addition to the cellular communication scheme, the wireless communication interface 2012 may support another type of wireless communication scheme, such as a short-range wireless communication scheme, a near field communication scheme, and a wireless local area network (LAN) scheme. In this case, the wireless communication interface 2012 may include a BB processor 2013 and an RF circuit 2014 for each wireless communication scheme.

Each of the antenna switches 2015 switches a connection destination of the antenna 916 among multiple circuits included in the wireless communication interface 2012 (for example, circuits for different wireless communication schemes).

Each of the antennas 2016 includes a single or multiple antenna elements (such as multiple antenna elements included in a MIMO antenna), and is used for the wireless communication interface 2012 to transmit and receive wireless signals. As shown in FIG. 20, the smart phone 2000 may include multiple antennas 2016. Although FIG. 20 shows an example in which the smart phone 2000 includes multiple antennas 2016, the smart phone 2000 may also include a single antenna 2016.

In addition, the smart phone 2000 may include an antenna 2016 for each wireless communication scheme. In this case, the antenna switch 2015 may be omitted from the configuration of the smart phone 2000.

The processor 2001, the memory 2002, the storage device 2003, the external connection interface 2004, the camera device 2006, the sensor 2007, the microphone 2008, the input device 2009, the display device 2010, the speaker 2011, the wireless communication interface 2012, and the auxiliary controller 2019 are connected to each other via the bus 2017. The battery 2018 supplies power to each block of the smart phone 2000 shown in FIG. 20 via a feeder line, and the feeder line is partially shown as a dashed line in the Figure. The auxiliary controller 2019, for example, operates the least necessary function of the smart phone 2000 in the sleep mode.

In the smart phone 2000 as shown in FIG. 20, the functions of the controlling unit 220 in the electronic device 200 described with reference to FIG. 15 may be implemented by the controller 2001 or the auxiliary controller 2019. For example, the controller 2001 or the auxiliary controller 2019 may perform functions of the controlling unit by executing instructions stored in the memory 2002 or in the storage device 2003. The transceiver unit 210 in the electronic device 200 may be implemented by the wireless communication interface 2012 (for example, under the control of the controller 2001 or the auxiliary controller 2019). In addition, the storage unit not shown in the electronic device 200 may be implemented by the memory 2002 or the storage device 2003.

### Second Application Example

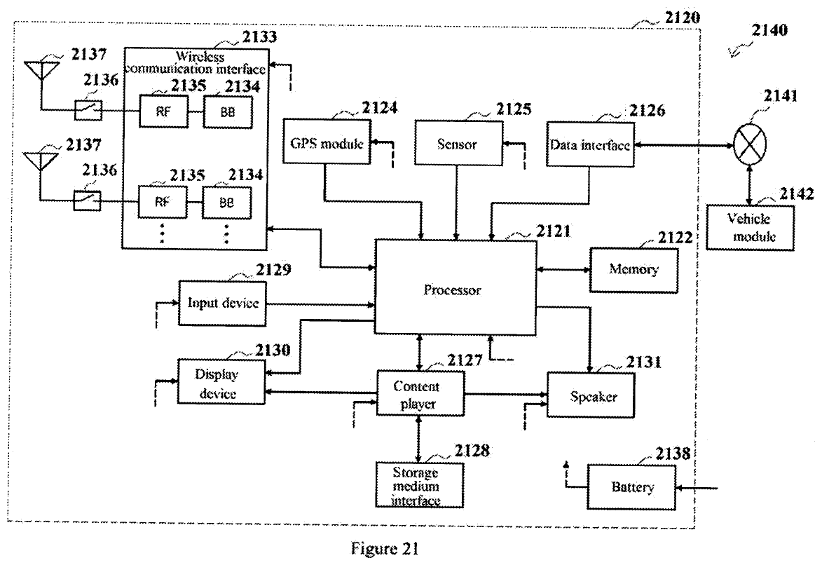

FIG. 21 is a block diagram showing an example of a schematic configuration of a vehicle navigation device 2120 to which the technology according to the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a wireless communication interface 2133, one or more antenna switches 2136, one or more antennas 2137, and a battery 2138.

The processor 2121 may be, for example, a CPU or a SoC, and controls the navigation function of the vehicle navigation device 2120 and other functions. The memory 2122 includes an RAM and an ROM, and stores data and programs executed by the processor 2121.

The GPS module 2124 measures a position (such as latitude, longitude, and altitude) of the vehicle navigation device 2120 based on a GPS signal received from a GPS satellite. The sensor 2125 may include a group of sensors, such as a gyroscope sensor, a geomagnetic sensor, and an air pressure sensor. The data interface 2126 is connected to, for example, an in-vehicle network 2141 via a terminal not shown, and acquires data (such as vehicle speed data) generated by the vehicle.

The content player 2127 reproduces content stored in a storage medium (such as CD and a DVD), which is inserted into the storage medium interface 2128. The input device 2129 includes, for example, a touch sensor, a button, or a switch configured to detect a touch on a screen of the display device 2130, and receives an operation or information input from the user. The display device 2130 includes a screen such as an LCD or OLED display, and displays an image of a navigation function or reproduced content. The speaker 2131 outputs the sound of the navigation function or the reproduced content.

The wireless communication interface 2133 supports any cellular communication scheme (such as LTE and LTE-Advanced), and performs wireless communication. The wireless communication interface 2133 may generally include, for example, a BB processor 2134 and an RF circuit 2135. The BB processor 2134 may perform, for example, encoding/decoding, modulation/demodulation, and multiplexing/demultiplexing, and perform various types of signal processing for wireless communication. Further, the RF circuit 2135 may include, for example, a mixer, a filter, and an amplifier, and transmit and receive wireless signals via the antenna 2137. The wireless communication interface 2133 may also be a chip module on which the BB processor 2134 and the RF circuit 2135 are integrated. As shown in FIG. 21, the wireless communication interface 2133 may include multiple BB processors 2134 and multiple RF circuits 2135. Although FIG. 21 shows an example in which the wireless communication interface 2133 includes multiple BB processors 2134 and multiple RF circuits 2135, the wireless communication interface 2133 may also include a single BB processor 2134 or a single RF circuit 2135.

In addition to the cellular communication scheme, the wireless communication interface 2133 may support other types of wireless communication schemes, such as a short-range wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches a connection destination of the antenna 2137 among multiple circuits included in the wireless communication interface 2133 (such as, circuits for different wireless communication schemes).

Each of the antennas 2137 includes a single or multiple antenna elements (such as multiple antenna elements included in a MIMO antenna), and is used for the wireless communication interface 2133 to transmit and receive wireless signals. As shown in FIG. 21, the vehicle navigation device 2120 may include multiple antennas 2137. Although FIG. 21 shows an example in which the vehicle navigation device 2120 includes multiple antennas 2137, the vehicle navigation device 2120 may also include a single antenna 2137.

In addition, the vehicle navigation device 2120 may include an antenna 2137 for each wireless communication scheme. In this case, the antenna switch 2136 may be omitted from the configuration of the vehicle navigation device 2120.

The battery 2138 supplies power to each block of the vehicle navigation device 2120 as shown in FIG. 21 via a feeder line, and the feeder line is partially shown as a dashed line in the Figure. The battery 2138 accumulates electric power supplied from the vehicle.

In the vehicle navigation device 2120 shown in FIG. 21, the functions of the controlling unit 220 in the electronic device 200 described with reference to FIG. 15 may be implemented by the controller 2121. For example, the controller 2121 may perform functions of the controlling unit by executing instructions stored in the memory 2122. The transceiver unit 210 in the electronic device 200 may be implemented by the wireless communication interface 2133 (for example, under the control of the controller 2121). In addition, the storage unit not shown in the electronic device 200 may be implemented by the memory 2122.

The technology of the present disclosure may also be implemented as an in-vehicle system (or vehicle) 2140 including one or more blocks in a vehicle navigation device 2120, the in-vehicle network 2141, and the vehicle module 2142. The vehicle module 2142 generates vehicle data (such as vehicle speed, engine speed, and failure information), and outputs the generated data to the in-vehicle network 2141.

The preferred embodiments of the present disclosure have been described above with reference to the accompanying drawings. Apparently, the present disclosure is not limited to the above embodiments. Those skilled in the art may obtain various changes and modifications within the scope of the appended claims, and it should be understood that these changes and modifications are fall within the technical scope of the present disclosure.

For example, the units shown in dashed boxes in the functional block diagrams shown in the drawings indicate that the functional units are optional in the corresponding device, and the various optional functional units may be combined in an appropriate manner to perform required functions.

For example, the functions included in one unit according to the above embodiments may be realized by separate devices. Alternatively, the functions implemented by multiple units in the above embodiments may be implemented by separate devices, respectively. In addition, one of the above functions may be implemented by multiple units. It should be understood that the above configurations are included in the technical scope of the present disclosure.

In this specification, the steps described in the flowchart may be performed in the chronological order described herein, and may be performed in parallel or independently rather than necessarily in the chronological order. In addition, the chronological order in which the steps are performed may be changed appropriately.

Although the embodiments of the present disclosure have been described above in detail in connection with the drawings, it should be appreciated that the embodiments described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic device for wireless communication, comprising:
processing circuitry, configured to:
obtain a measurement result of a communication link between a user equipment and a candidate base station with assistance of an intelligent reflecting surface in a case that a current serving base station of the user equipment is overloaded; and
enable the user equipment to access the candidate base station and perform communication between the user equipment and the candidate base station with assistance of the intelligent reflecting surface in a case that the measurement result of the communication link is higher than a threshold.

2. The electronic device according to claim 1, wherein the processing circuitry is further configured to:
receive relevant information of the user equipment and a measurement request for the communication link, which are transmitted to the candidate base station by the current serving base station when the current serving base station receives, in a case of being overloaded, an uplink scheduling request from the user equipment; and
control measurement on the communication link based on the relevant information in response to the measurement request.

3. The electronic device according to claim 2, wherein the processing circuitry is further configured to:
determine, based on the relevant information, an intelligent reflecting surface or a plurality of intelligent reflecting surfaces that can be cascaded between the user equipment and the candidate base station to assist communication.

4. The electronic device according to claim 2, wherein the processing circuitry is further configured to:
control a first beam of the intelligent reflecting surface to be directed to the user equipment and/or a second beam of the intelligent reflecting surface to be directed to the candidate base station, to establish a reflecting link between the user equipment and the candidate base station via the intelligent reflecting surface.

5. The electronic device according to claim 4, wherein the processing circuitry is further configured to:
measure an uplink reference signal transmitted by the user equipment and received via the communication link comprising the reflecting link and a direct link between the user equipment and the candidate base station; and
obtain the measurement result of the communication link based on a measurement result of the uplink reference signal.

6. The electronic device according to claim 2, wherein the processing circuitry is further configured to:
provide the measurement result of the communication link to the current serving base station of the user equipment, so that the current serving base station instructs the user equipment to disconnect from the current serving base station and access to the candidate base station in the case that the measurement result is higher than the threshold.

7. The electronic device according to claim 1, wherein the processing circuitry is further configured to:
receive a random access request transmitted by the user equipment to the candidate base station in a case that the user equipment is unable to obtain uplink resources from the overloaded current serving base station; and
control measurement on the communication link based on the received random access request.

8. The electronic device according to claim 7, wherein the processing circuitry is further configured to:
in a case that the intelligent reflecting surface is not used, transmit a first downlink reference signal sequentially with a plurality of first beams, and receive a first random access request transmitted by the user equipment to the candidate base station with a beam corresponding to one of the plurality of first beams; and
transmit a second downlink reference signal to the intelligent reflecting surface and control the intelligent reflecting surface to reflect the second downlink reference signal sequentially with a plurality of second beams, and receive a second random access request reflected by the intelligent reflecting surface and transmitted by the user equipment to the intelligent reflecting surface with a beam corresponding to one of the plurality of second beams.

9. The electronic device according to claim 8, wherein the processing circuitry is further configured to:
provide, through the current serving base station of the user equipment, first information about the first downlink reference signal to the user equipment, wherein the first information comprises relevant information about the candidate base station; and provide, through the current serving base station of the user equipment, second information about the second downlink reference signal to the user equipment, wherein the second information comprises relevant information about the intelligent reflecting surface, and/or
measure the received first random access request and the received second random access request to obtain the measurement result of the communication link; and transmit a random access response to the user equipment in a case that the measurement result of the communication link is higher than the threshold.

10. (canceled)

11. The electronic device according to claim 1, wherein the processing circuitry is further configured to:
during the communication between the user equipment and the candidate base station with assistance of the intelligent reflecting surface, transmit a downlink reference signal to the user equipment, and obtain a measurement result of the downlink reference signal from the user equipment as a communication quality of the communication link.

12. The electronic device according to claim 1, wherein the processing circuitry is further configured to:
during the communication between the user equipment and the candidate base station with assistance of the intelligent reflecting surface, transmit a downlink reference signal to the user equipment only through a reflecting link via the intelligent reflecting surface, and obtain a measurement result of the downlink reference signal from the user equipment as a communication quality of the reflecting link.

13. (canceled)

14. An electronic device for wireless communication, comprising:
processing circuitry, configured to:
transmit an uplink signal for measuring a communication link between a user equipment and a candidate base station with assistance of an intelligent reflecting surface in a case that a current serving base station is overloaded; and
access the candidate base station and perform communication between the user equipment and the candidate base station with assistance of the intelligent reflecting surface in a case that a measurement result of the communication link is higher than a threshold.

15. The electronic device according to claim 14, wherein the processing circuitry is further configured to:
transmit an uplink reference signal to the candidate base station via the communication link comprising a direct link between the user equipment and the candidate base station and a reflecting link through the intelligent reflecting surface, so that the candidate base station obtains the measurement result of the communication link based on a measurement result of the received uplink reference signal.

16. The electronic device according to claim 15, wherein the processing circuitry is further configured to:
disconnect from the current serving base station and access to the candidate base station based on an instruction transmitted from the current serving base station in the case that the measurement result of the communication link is higher than the threshold.

17. The electronic device according to claim 14, wherein the processing circuitry is further configured to:
transmit a random access request to the candidate base station in a case of being unable to obtain uplink resources from the overloaded current serving base station.

18. The electronic device according to claim 17, wherein the processing circuitry is further configured to:
in a case that the intelligent reflecting surface is not used, receive a first downlink reference signal transmitted by the candidate base station sequentially with a plurality of first beams, and transmit a first random access request to the candidate base station with a beam corresponding to one of the plurality of first beams; and
receive a second downlink reference signal from the candidate base station reflected by the intelligent reflecting surface sequentially with a plurality of second beams, and transmit a second random access request to the intelligent reflecting surface with a beam corresponding to one of the plurality of second beams for the intelligent reflecting surface to reflect the second random access request to the candidate base station.

19. The electronic device according to claim 18, wherein the processing circuitry is further configured to:
obtain first information about the first downlink reference signal provided by the candidate base station through the current serving base station, wherein the first information comprises relevant information about the candidate base station; and obtain second information about the second downlink reference signal provided by the candidate base station through the current serving base station, wherein the second information comprises relevant information about the intelligent reflecting surface and/or,
receive a random access response transmitted by the candidate base station to the user equipment in a case that the candidate base station determines that the measurement result of the communication link is higher than the threshold based on a measurement result of the received first random access request and the received second random access request.

20. (canceled)

21. The electronic device according to claim 14, wherein the processing circuitry is further configured to:
during the communication between the user equipment and the candidate base station with assistance of the intelligent reflecting surface, measure a downlink reference signal transmitted by the candidate base station to the user equipment, and report a measurement result of the downlink reference signal to the candidate base station as a communication quality of the communication link.

22. The electronic device according to claim 14, wherein the processing circuitry is further configured to:
during the communication between the user equipment and the candidate base station with assistance of the intelligent reflecting surface, measure a downlink reference signal transmitted by the candidate base station to the user equipment only through a reflecting link via the intelligent reflecting surface, and report a measurement result of the downlink reference signal to the candidate base station as a communication quality of the reflecting link via the intelligent reflecting surface.

23.-24. (canceled)

25. A method for wireless communication, comprising:
transmitting an uplink signal for measuring a communication link between a user equipment and a candidate base station with assistance of an intelligent reflecting surface in a case that a current serving base station is overloaded; and
accessing the candidate base station and performing communication between the user equipment and the candidate base station with assistance of the intelligent reflecting surface in a case that a measurement result of the communication link is higher than a threshold.

26. (canceled)
